(19) United States
(12) Patent Application Publication
(10) Pub. No.: US 2026/0311301 A1
(43) Pub. Date: Oct. 8, 2026

(54) DENOISING IMAGES OF DYNAMICALLY DISPLACED PARAMETRIC SURFACES

(71) Applicant: NVIDIA CORPORATION, Santa Clara, CA (US)

(72) Inventors: Ardavan Kanani, Germantown, MD (US); Manuel Kraemer, San Jose, CA (US); Jesse Dylan Lacewell, Fremont, CA (US); Jan Andrik Oliver Schmid, Stockholm (SE)

(21) Appl. No.: 19/439,927

(22) Filed: Jan. 5, 2026

Related U.S. Application Data
(63) Continuation of application No. 19/439,895, filed on Jan. 5, 2026.
(60) Provisional application No. 63/753,458, filed on Feb. 4, 2025.

(51) Int. Cl. G06T 5/70; G06T 15/06; G06T 15/10

(52) U.S. Cl. CPC G06T 5/70; G06T 15/06; G06T 15/10; G06T 2207/20182

(57) ABSTRACT

In various examples, images of geometrically refined parametric surfaces may be denoised using motion vectors computed in 2D screen space and/or using locations of corresponding control points. Surfaces in a scene may be geometrically refined (e.g., subdivided or tessellated), an image of the scene may be ray traced or rasterized, and motion vectors may be computed in 2D screen space and/or using corresponding control points on the control cages for geometrically refined parametric surfaces. In some embodiments with displaced surfaces, motion vectors are computed by comparing 3D locations on a rendered (displaced) surface or by comparing corresponding 3D locations on the limit surface, and displacement may be determined using the applicable displacement function (e.g., a displacement map, texture, procedural math function, some combination thereof) or by measuring or deriving it from approximated locations on the displaced and limit surfaces. As such, the image may be denoised using the motion vectors.

### CROSS-REFERENCE TO RELATED APPLICATIONS

This application is a continuation of U.S. patent application Ser. No. 19/439,895, filed Jan. 5, 2026, which claims the benefit of U.S. Provisional Application No. 63/753,458, filed on Feb. 4, 2025. The contents of each of the foregoing applications are hereby incorporated by reference in their entirety.

### BACKGROUND

In three-dimensional (3D) modeling and rendering, parametric surfaces such as Bezier surfaces, Basis splines (B-splines), Non-Uniform Rational B-Splines (NURBS), and subdivision surfaces (subds) provide a smooth, mathematically defined way to represent 3D objects. Instead of explicitly storing millions of polygons, parametric surfaces define geometry using a set of control points and equations that interpolate or approximate a smooth surface. The set of control points (or control vertices) for a 3D object form its control cage or control mesh, a coarse 3D model that influences the shape of the final parametric surface. The control cage is typically created by an artist or visualization designer using 3D modeling software (e.g., Blender, Maya, Rhino, Computer-Aided Design (CAD) software). Once the control cage is defined, the surface may be mathematically represented using a parametric function that maps a two-dimensional (2D) coordinate system (u,v) into a 3D surface. Typically, the surface is divided into two-dimensional (2D) patches, with each patch using a local 2D parametric domain [0,1]² to represent the 3D positions of its control points from the control cage. The type of parametric surface representation (e.g., B-splines, NURBS, Bézier patches) typically determines the algorithm used to decompose the 3D surface into patches and assign control points from the control cage to corresponding patches. The parametric function maps each patch to a corresponding portion of an ideal, smooth 3D surface called the limit surface, and various techniques may be used to provide continuity (e.g., smoothness) across patch boundaries. Dividing the 3D surface into 2D parametric patches facilitates efficient evaluation, rendering, and manipulation of complex surfaces without requiring a single, massive equation for the entire surface. As a result, the control points of the control cage may be used as inputs to the parametric function to interpolate or approximate points on the limit surface between the control points.

Although parametric surfaces provide a useful way to define 3D geometry, modern graphics hardware cannot directly render them. Since modern graphics hardware is optimized to process and display polygonal meshes rather than continuous mathematical surfaces, these surfaces are typically geometrically refined into a collection of triangles or quads for rendering. There are two primary techniques for geometric refinement: subdivision and tessellation. Subdivision iteratively refines a coarse control mesh by splitting its faces into smaller ones, gradually converging toward the smooth limit surface. In contrast, tessellation samples the parametric surface at specific points and constructs a polygonal mesh from those samples, allowing vertices to be placed directly on the limit surface. One advantage of tessellation is that it can be adaptive or dynamic—meaning the level of detail may be adapted in real-time based on factors like screen-space resolution, curvature, or viewing distance. This adaptive approach facilitates efficient rendering by refining the surface only where it is needed, reducing computational costs while preserving visual quality.

Whether ray tracing or rasterizing the geometrically refined surfaces, existing techniques typically rely on motion vectors for denoising. Denoising is especially useful in ray tracing, where accurate light simulations would typically need millions or even billions of rays per frame, whereas ray tracing in interactive applications (e.g., video games or real-time visualization) can rarely afford more than a single sample (ray) per pixel due to latency constraints, often leading to images with substantial noise. Denoising may be implemented using spatio-temporal accumulation, which reuses information from previous frames and neighboring pixels to improve image quality. To perform spatio-temporal accumulation, existing techniques use motion vectors to track the movement of rendered surfaces from one frame to the next. However, the geometric refinement process for parametric surfaces tends to generate very large amounts of micro-triangles, and storing a motion vector for each micro-vertex scales very poorly (both in processing time and memory usage). Furthermore, computing motion vectors becomes rapidly intractable for dynamically tessellated surfaces. With dynamic tessellation, the topology of the micro-triangle mesh can change every frame, making it impossible to compute the position delta of any given micro-vertex across frames.

As a result, there is a need for improved techniques to support denoising images of geometrically refined surfaces.

### SUMMARY

Embodiments of the present disclosure relate to denoising images of geometrically refined parametric surfaces. For example, systems and methods for visual rendering are disclosed in which surfaces in a scene may be geometrically refined using any desired technique (e.g., subdivision or tessellation), an image of the scene may be ray traced or rasterized, motion vectors may be computed in 2D screen space and/or using corresponding control points on the control cages for geometrically refined parametric surfaces, and the image may be denoised using the motion vectors.

Generally, the location on a rendered, geometrically refined (e.g., tessellated, subdivided) surface each pixel depicts (e.g., ray intersection points in ray tracing, interpolated locations within rasterized triangles) may be represented as a corresponding parametric location on the limit surface anchored in the topology of the control cage (e.g., via a corresponding patch). And since the topology of the control cage should not change from frame to frame, the corresponding patch and parametric location within the patch should not change from frame to frame. As a result, the motion of points on rendered, geometrically refined surfaces may be computed using corresponding parametric locations on the limit surface (which may be resolved to 3D using the coordinates of corresponding control cage vertices via the applicable parametric equation for the surface), obviating the need to cache the locations of the (e.g., millions of) micro-vertices of geometrically refined surfaces (which would likely waste memory and computation resources anyway, as denoisers typically only use motion vectors for visible micro-triangles).

Additionally or alternatively (e.g., instead of computing motion vectors for each vertex of a geometrically refined surface or its corresponding control cage), motion vectors may be computed in screen space, for example, by iterating over individual pixels, identifying pixels that represent rendered parametric surfaces, and computing motion vectors for those pixels. Computing motion vectors for pixels in 2D screen space frees up computational resources and memory by obviating the need to compute motion vectors for each vertex in 3D space and by obviating the need to resolve which motion vectors correspond to visible micro-triangles.

In some embodiments, the motion of a rendered (e.g., limit, displaced) surface may be computed by reconstructing and comparing 3D locations on the limit surface from frame to frame. For example, current and previous 3D locations on the limit surface may be reconstructed using the parametric location of the limit surface each pixel represents or depicts, and the current and previous 3D locations may be projected into screen space and compared to generate a corresponding motion vector. This technique may be used to compute the motion of a corresponding point on the limit surface, for example, when a pixel represents or depicts a rendered limit surface without displacement, or when a pixel represents or depicts a rendered displaced surface and the motion of the displaced surface is approximated using the motion of the limit surface.

In some embodiments with objects or scenes with displaced surfaces, motion vectors may be computed by comparing 3D locations on the rendered (displaced) surface or by comparing corresponding 3D locations on the limit surface, and displacement may be determined using the applicable displacement function (e.g., a displacement map, texture, procedural math function, some combination thereof) or by measuring or deriving it from approximated locations on the displaced and limit surfaces.

As such, images may be rendered, motion vectors may be computed, and the motion vectors may be used to denoise the rendered image.

### BRIEF DESCRIPTION OF THE DRAWINGS

The present systems and methods for denoising images of geometrically refined parametric surfaces are described in detail below with reference to the attached drawing figures, wherein:

FIG. 1 is a block diagram of an example rendering pipeline, in accordance with some embodiments of the present disclosure;

FIG. 2 illustrates a portion of an example control cage and corresponding limit surface and geometrically refined surfaces, in accordance with some embodiments of the present disclosure;

FIG. 3 illustrates some example motion vectors, in accordance with some embodiments of the present disclosure;

FIG. 4 is a flow diagram showing a method for computing a motion vector by comparing 3D positions on the limit surface, in accordance with some embodiments of the present disclosure;

FIG. 5 is a flow diagram showing a method for computing a motion vector by comparing a current 3D position on a displaced surface to a previous 3D position on the displaced surface reconstructed using derived displacement, in accordance with some embodiments of the present disclosure;

FIG. 6 is a flow diagram showing a method for computing a motion vector by comparing a current 3D position on a displaced surface to a previous 3D position on the displaced surface reconstructed using a displacement function, in accordance with some embodiments of the present disclosure;

FIG. 7 is a flow diagram showing a method for computing a motion vector by comparing current and previous 3D positions on a displaced surface reconstructed using a displacement function, in accordance with some embodiments of the present disclosure;

FIG. 8 is a flow diagram showing a method for computing a motion vector based at least on a current location and a reconstructed previous location on a limit surface, in accordance with some embodiments of the present disclosure;

FIG. 9 is a flow diagram showing a method for computing a motion vector based at least on a current location on a displaced surface and a reconstructed previous location on the limit surface, in accordance with some embodiments of the present disclosure;

FIG. 10 illustrates a parallel processing unit, in accordance with some embodiments of the present disclosure;

FIG. 11A illustrates a general processing cluster within the parallel processing unit of FIG. 10, in accordance with some embodiments of the present disclosure;

FIG. 11B illustrates a memory partition unit of the parallel processing unit of FIG. 10, in accordance with some embodiments of the present disclosure;

FIG. 12A illustrates the streaming multi-processor of FIG. 11A, in accordance with some embodiments of the present disclosure;

FIG. 12B is a conceptual diagram of a processing system implemented using the PPU of FIG. 10, in accordance with some embodiments of the present disclosure;

FIG. 12C illustrates an example system in which the processing system of FIG. 12B may be implemented, in accordance with some embodiments of the present disclosure;

FIG. 13 is a conceptual diagram of a graphics processing pipeline implemented by the parallel processing unit of FIG. 10, in accordance with some embodiments of the present disclosure;

FIG. 14 is a block diagram of an example computing device, in accordance with at least some embodiments of the present disclosure; and

FIG. 15 is a block diagram of an example data center suitable for use in implementing some embodiments of the present disclosure.

### DETAILED DESCRIPTION

Systems and methods are disclosed relating to denoising images of geometrically refined parametric surfaces. For example, instead of computing a motion vector for each geometrically refined micro-vertex in a 3D scene, motion vectors may be computed in 2D screen space and/or using corresponding control points on the control cage for the geometrically refined parametric surface. As such, the surface may be refined using any desired technique (e.g., subdivision or tessellation), an image of the scene may be ray traced or rasterized, and motion vectors may be computed by sampling the limit surface of the control cage (e.g., only) at the locations of visible micro-vertices. As such, there is no need to track the potentially millions of geometrically refined micro-vertices. Accordingly, images may be rendered and denoised using the motion vectors in a process that decouples the workload from the complexity of the scene.

For a given frame N, the frame may be ray traced or rasterized, and for each pixel that represents or depicts a parametric surface, the 3D location on its rendered (e.g., limit) surface the pixel represents or depicts and a corresponding parametric representation (e.g., a 2D parametric location anchored in the topology of the control cage via a corresponding patch) may be computed. A buffer may be used to store the parametric locations corresponding to the 3D locations on the rendered surface, the parametric locations may be used to reconstruct the previous 3D locations on the rendered surface using cached locations of the control points of the posed control cage from the previous frame, and the current and previous 3D locations of the rendered surface may be used to compute corresponding motion vectors in screen space (e.g., by projecting the current and previous 3D locations onto the screen using the current camera configuration and taking the vector difference of the projected points).

In some scenarios, an artist or visualization designer may define a displacement map or displacement function to modify a surface in a way that simulates geometric detail, texture, or shading effects. Displacement is usually specified as a 2D displacement map (e.g., a grayscale texture stored in (u,v) space), a procedural math function, or a combination of both (e.g., implemented as a graph of computational nodes that may incorporate dozens of textures and hundreds of mathematical operations). As such, a displacement map or displacement function may be evaluated at a parametric location (u,v) to produce a scalar value that represents how much the surface should be spatially displaced (e.g., pushed outward or pulled inward) from the limit surface along the surface normal to create a more detailed, displaced surface.

For objects or scenes with displaced surfaces, when a pixel represents or depicts a parametric surface—whether by intersecting it with a primary ray in ray tracing or by being covered by a rasterized triangle that approximates the surface in rasterization—the rendered surface the pixel represents or depicts is typically the displaced surface rather than the limit surface. There are a few possible ways for the motion vector computations to handle displacement, whether comparing 3D locations on the rendered (displaced) surface or comparing corresponding 3D locations on the limit surface. For example (e.g., if the displacement computation is relatively inexpensive such as a texture lookup) and taking comparison of 3D locations on the rendered (displaced) surface as an example, the 3D locations on the rendered (displaced) surface each applicable pixel represents or depicts may be computed (e.g., reconstructed from cached depth values under each pixel and the camera configuration), the cached parametric locations corresponding to the 3D locations on the rendered (displaced) surface may be used to reconstruct the previous 3D locations on the limit surface using cached locations of the control points of the posed control cage from the previous frame, displacement may be evaluated and used to displace the previous 3D locations on the limit surface, and the current and previous 3D locations of the displaced surface may be used to compute corresponding motion vectors in screen space. In another example that compares 3D locations on the rendered (displaced) surface, the 3D locations on the limit surface may be computed (e.g., reconstructed from the cached parametric locations) and converted to corresponding 3D locations on the rendered (displaced) surface using a calculated displacement, the cached parametric locations may be used to reconstruct the corresponding 3D locations on the limit surface in the previous frame, the calculated displacement may be used to convert to the corresponding 3D location on the rendered (displaced) surface in the previous frame, and the current and previous 3D locations of the displaced surface may be used to compute corresponding motion vectors in screen space. In an example that involves comparing 3D locations on the limit surface, the 3D locations on the rendered (displaced) surface each applicable pixel represents or depicts may be computed (e.g., reconstructed from cached depth values under each pixel and the camera configuration) and converted to corresponding 3D locations on the limit surface by evaluating and removing displacement, and the current and previous 3D locations of the limit surface may be used to compute corresponding motion vectors in screen space.

In some embodiments (e.g., if the displacement computation is relatively expensive relative to the parametric function), displacement may effectively be measured or derived. For example, the cached parametric locations corresponding to the 3D locations on the displaced surface may be used to reconstruct the 3D locations on the limit surface using the posed control cage from the current frame, and the reconstructed 3D locations on the limit surface may be subtracted from the 3D locations on the displaced surface each applicable pixel represents or depicts to derive displacement. The cached parametric locations corresponding to the 3D locations on the displaced surface may be used to reconstruct the previous 3D locations on the limit surface using cached locations of the control points of the posed control cage from the previous frame, the derived displacement may be applied to reconstruct the previous 3D locations on the displaced surface, and the current and previous 3D locations of the displaced surface may be used to compute corresponding motion vectors in screen space.

As such, images may be rendered, motion vectors may be computed, and the motion vectors may be used to denoise the rendered image using any known technique. The techniques described herein result in a variety of benefits. For example, by using the control points on the control cage to reconstruct the locations used to compute motion vectors, the topology of the geometry being rendered does not need to remain consistent from frame to frame for the motion vector computation to remain tractable. For example, dynamic tessellation may be used to generate entirely different meshes each frame, and motion vectors may be computed using the fixed topology of a corresponding control cage, which is typically much sparser than the tessellated mesh. As such, the resulting images may be denoised using motion vectors computed using control points on the control cage to reconstruct corresponding 3D locations (e.g., instead of tracking every tessellated vertex in the 3D scene) for visible surface locations in screen space (e.g., instead of for every tessellated or control vertex in the 3D scene). These simplifications effectively decouple the computational and memory costs from the scene geometry, enabling the use of a variety of geometry refinement techniques, while dramatically reducing the computational costs and memory costs.

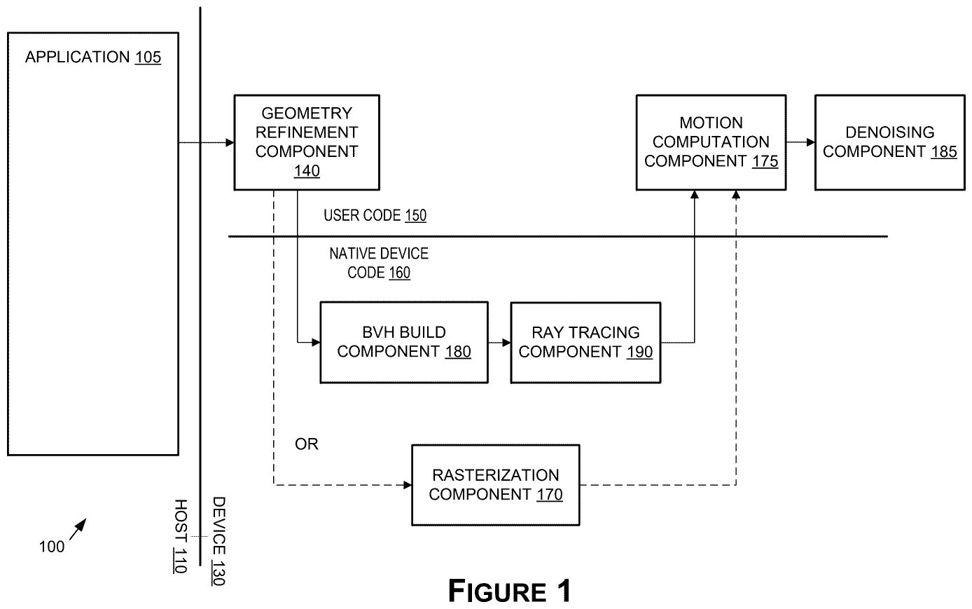

With reference to FIG. 1, FIG. 1 is an example rendering pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

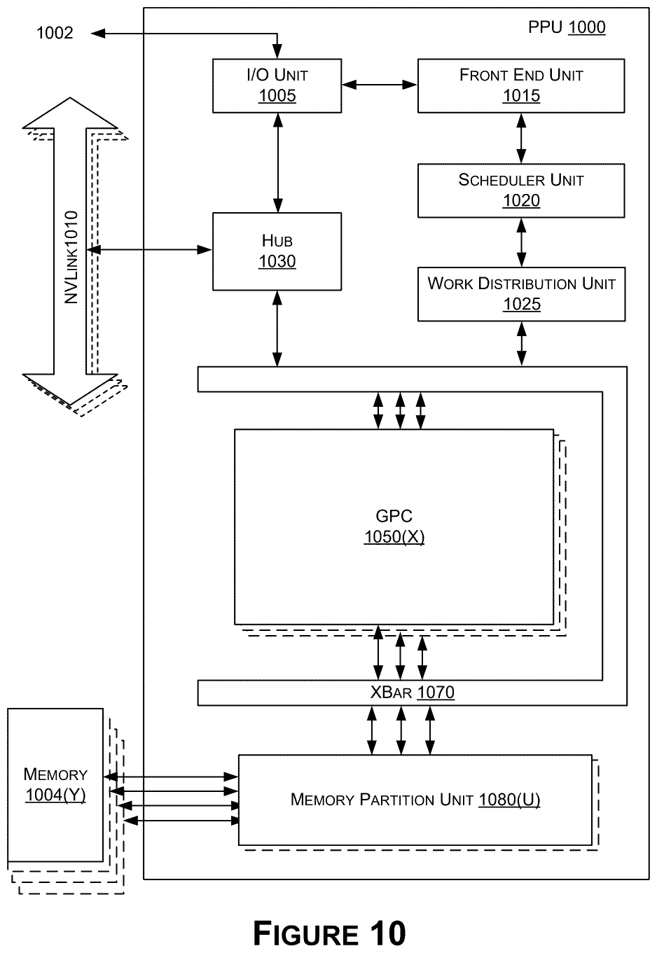

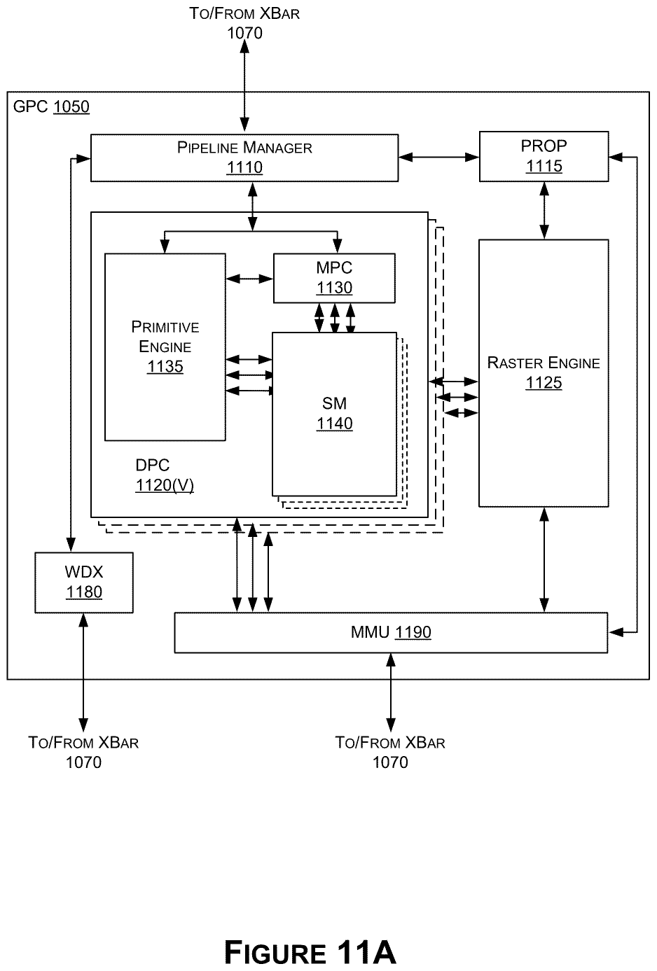

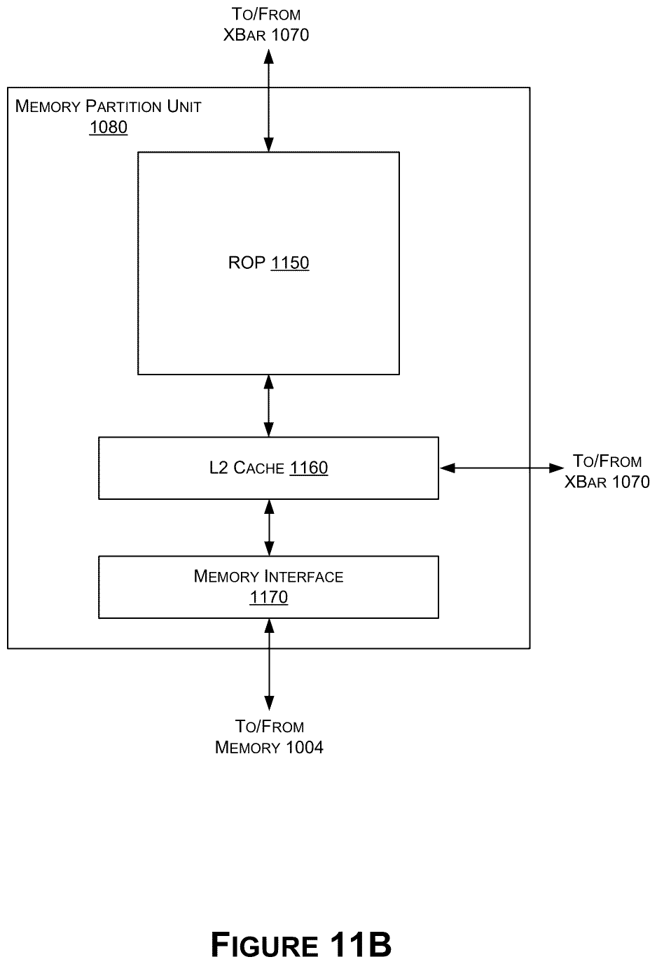

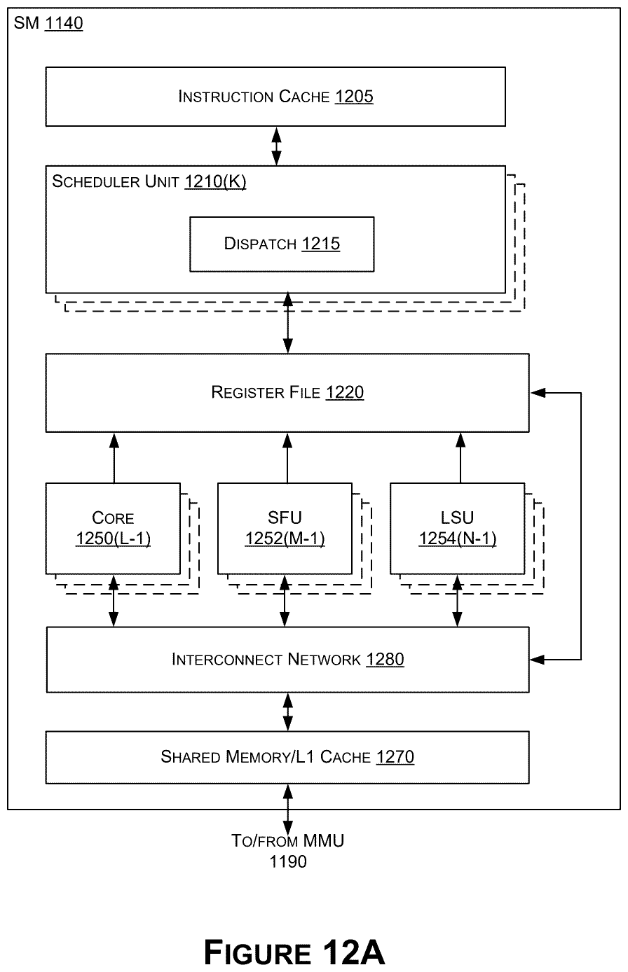

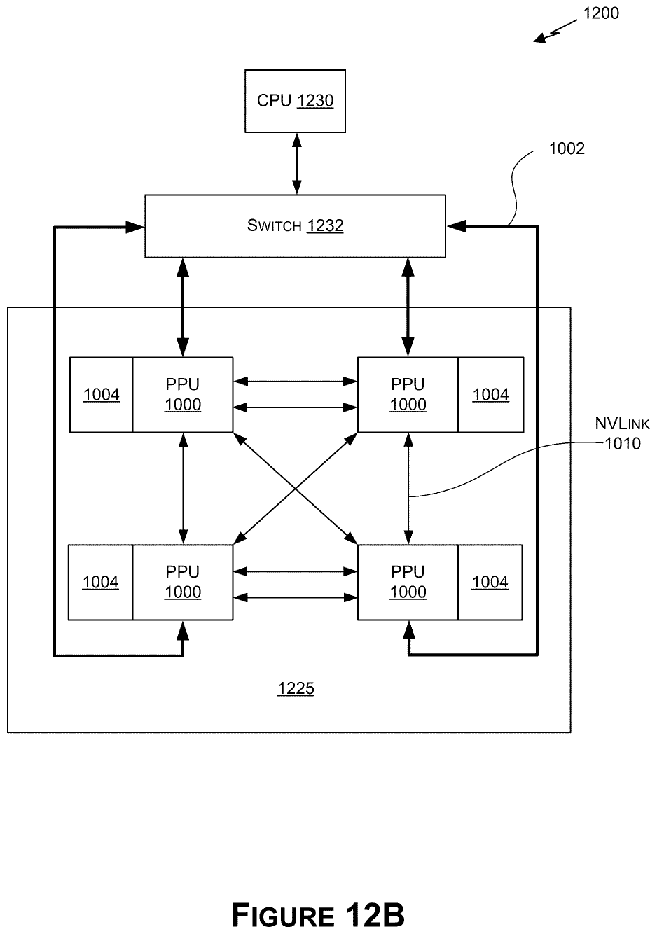

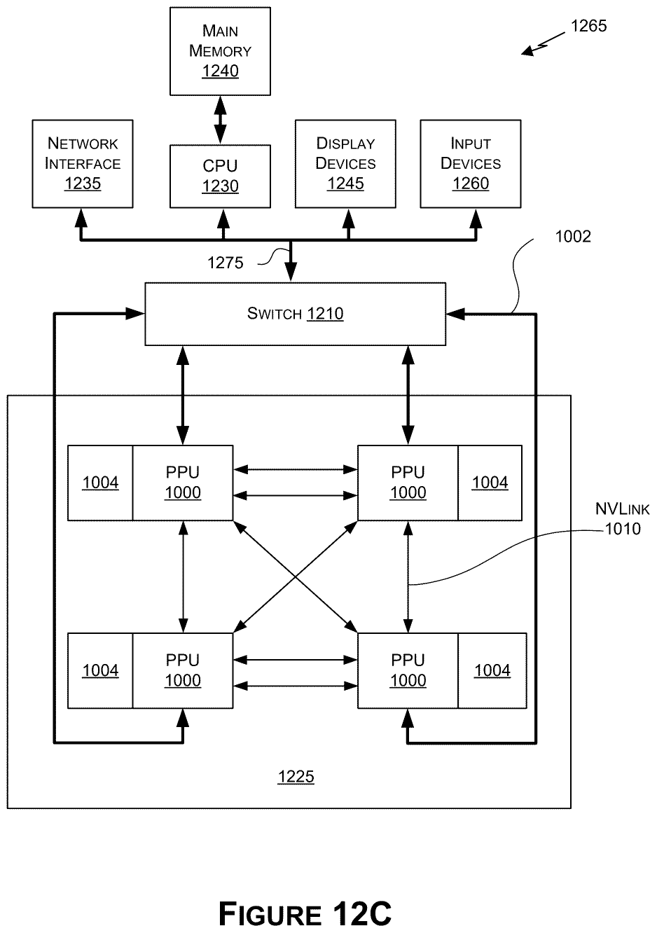

In FIG. 1, the rendering tracing pipeline 100 may be implemented via an application 105 executed by a host 110 (e.g., a central processing unit (CPU) that runs application logic and coordinates task execution with a device 130 (e.g., a parallel processor (e.g., the PPU 10 of FIG. 10) such as a GPU), which may be optimized for parallel processing and high-performance tasks like rendering, shading, or ray tracing. In this example, the device 130 includes user code 150 such as custom program(s) that may be written by a developer in a shading language (e.g., OpenGL Shading Language (GLSL), High-Level Shading Language (HLSL)) to execute specific tasks on the device 130. By contrast, the native device code 160 typically represents built-in or configurable functions provided by the manufacturer of the device 130, and may operate a lower level (e.g., embedded within drivers, built-in libraries, firmware, etc.). The device 130 may include one or more multi-threaded processors (e.g., a streaming multiprocessor (SM) such as the SM 1140 of FIG. 11A) that run the user code 150 (e.g., on general-purpose core(s) which may correspond to the cores 1250 of FIG. 12A) and/or the native device code 160 (e.g., on special function core(s) such as the special function unit(s) 1252 of FIG. 12A).

Generally, the application 105 may be any type of application that defines, updates, manages, and/or coordinates rendering a 3D scene (e.g., a video game, real-time rendering engine, physics simulation, CAD software, architectural visualization tool, film industry rendering, robotics simulation, AR or VR environment, etc.). At a high level, the application 105 may use any known technique to define and/or update (e.g., animate) the scene, and may coordinate with the device 130 to execute various stages of the rendering pipeline 100. Note that FIG. 1 illustrates alternate routes through the rendering pipeline 100, one for ray tracing and one for rasterization. Taking ray tracing as an example, the rendering pipeline 100 may include pre-processing (e.g., tessellation or subdivision, executed by a geometry refinement component 140), construction of a bounding volume hierarchy or BVH (e.g., executed by a BVH build component 180), and ray tracing a frame (e.g., executed by a ray tracing component 190). Taking rasterization as an example, the rendering pipeline 100 may include pre-processing (e.g., tessellation or subdivision, executed by the geometry refinement component 140) and rasterization of a frame (e.g., executed by a rasterization component 170). In either scenario, a motion computation component 175 may compute motion vectors representing the motion of surfaces rendered during ray tracing or rasterization of the frame, and a denoising component 185 may use the motion vectors to denoise the frame.

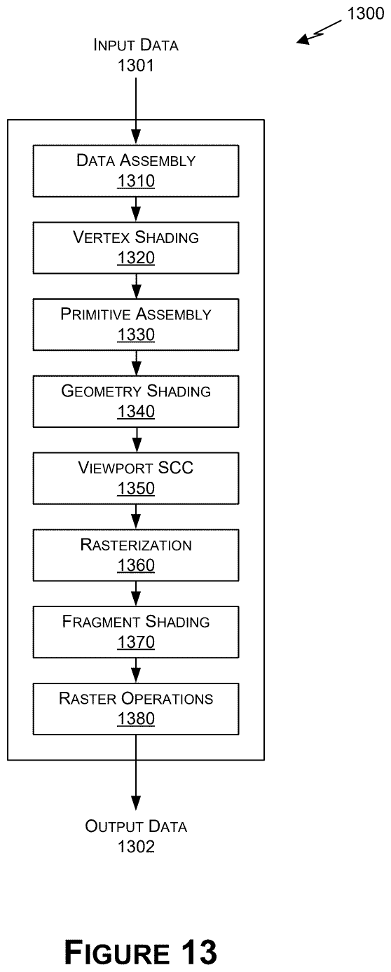

In an example implementation (e.g., every frame, every N frames, etc.), the application 105 may identify objects or parts of the scene (e.g., terrain, characters, objects, etc.) and send commands to the device 130 to refine the identified geometry based on specified parameters (e.g., levels of detail), the device 130 may run the geometry refinement component 140 (e.g., in the form of tessellation shader(s) or subdivision routine(s)) to geometrically refine the input geometry into finer detail using any known geometric refinement technique (e.g., subdivision or tessellation), and the process may repeat over some or all of the scene. Although the geometry refinement component 140 is illustrated in FIG. 1 as running on the device 130, in some embodiments, the geometry refinement component 140 performs subdivision or tessellation at least in part on the host 110 (e.g., as part of the application 105). As such, the geometry refinement component 140 may generate and return a representation of (or reference to) the refined surfaces in the scene, and the application 105 (or some other component) may trigger the device to ray trace or rasterize the scene using the refined surfaces. Taking ray tracing as an example, the application 105 may instruct the device 130 to build a BVH over the scene using any known technique, and the application 105 may coordinate ray tracing by assigning ray generation and shading tasks to the device 130, which the device 130 (e.g., the ray tracing component 190) may execute on special function core(s) to handle the BVH traversal and ray intersection calculations. Taking rasterization as an example, the application 105 may instruct the device 130 to rasterize the refined surfaces using any known technique (e.g., using the graphics processing pipeline 1300 of FIG. 13), and the application 105 may coordinate rasterization by assigning rasterization tasks to the device 130, which the device 130 (e.g., the rasterization component 170) may execute on special function core(s) to handle stages such as vertex shading, primitive assembly, rasterization, and fragment shading. Throughout the rendering pipeline 100, the application 105 and/or user code on the device 130 (e.g., the user code 150) may interact with the device 130 via any number of API calls to manage the data flow through the rendering pipeline 100 (e.g., from geometry refinement, through ray tracing or rasterization, motion computation, and denoising). The allocation of functionality among the application 105, user code (e.g., the user code 150) on the device 130, and native device code 160 (e.g., whether running on the device 130 or on the host 110) described herein is meant simply as an example, and variations may be implemented within the scope of the present disclosure.

The motion computation component 175 may compute motion vectors representing the motion of surfaces rendered during ray tracing or rasterization. Instead of computing and storing motion vectors for each micro-vertex of the geometrically refined surfaces, the motion computation component 175 may compute and resolve motion vectors directly in screen space. Depending on the implementation, the ray tracing component 190 may ray trace (or the rasterization component 170 may rasterize) some or all of a frame and use any known technique to create or populate a corresponding buffer (e.g., a cached hit buffer, G-buffer, depth buffer) with a representation of the location on a rendered (e.g., displaced, limit) surface each pixel represents or depicts (e.g., 3D coordinates of the approximated surface point, corresponding parametric coordinates in a patch of the parametric surface, depth, etc.), which the motion computation component 175 may use to compute motion vectors (e.g., concurrently or interleaved with ray tracing or rasterization, after the frame has been ray traced or rasterized).

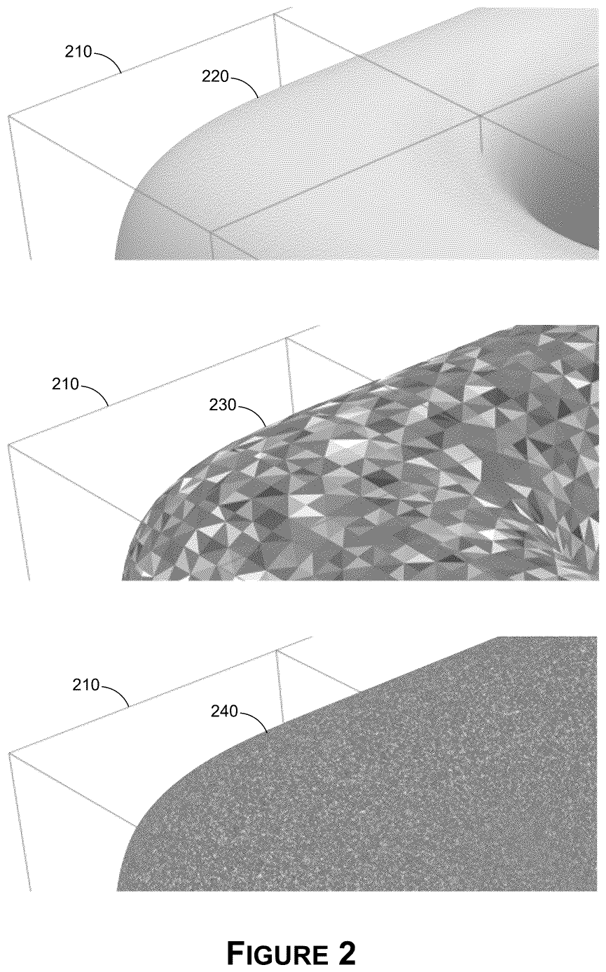

At a high level, instead of caching the locations of the micro-vertices of geometrically refined surfaces and using those locations to compute motion vectors, the corresponding locations of the control cage vertices may be cached (e.g., for one prior frame, by any suitable component such as the geometry refinement component 140 or the motion computation component 175), and the motion computation component 175 may use the cached locations of the control cage vertices to compute motion vectors. Generally, the location on a rendered geometrically refined (e.g., tessellated, subdivided) surface each pixel represents or depicts (e.g., ray intersection points in ray tracing, interpolated locations within rasterized triangles) may be represented as a corresponding parametric location on the limit surface anchored in the topology of the control cage (e.g., via a corresponding patch). And since the topology of the control cage should not change from frame to frame, the corresponding patch and parametric location within the patch should not change from frame to frame, and the motion of points on rendered geometrically refined surfaces may be computed using corresponding parametric locations on the limit surface (which may be resolved to 3D using the coordinates of corresponding control cage vertices via the applicable parametric equation for the surface), obviating the need to cache the locations of the (e.g., millions of) micro-vertices of geometrically refined surfaces. FIG. 2 illustrates a portion of an example control cage 210, a corresponding (Catmull Clark) limit surface 220, and corresponding geometrically refined surfaces 230 and 240. In this example, the geometrically refined surface 230 illustrates a low level of geometric refinement (e.g., tessellation) with visible micro-triangles. In many real-world applications, micro-triangles are diced to sub-pixel sizes, which are significantly smaller than the triangles shown in the geometrically refined surface 230. In contrast, the geometrically refined surface 240 illustrates a sub-pixel level of geometric refinement that produces micro-triangles smaller than a pixel. Notice how the control cage 210 is much sparser than the corresponding geometrically refined surfaces 230 and 240, illustrating the magnitude of the computational resources and memory freed up by caching locations of the vertices of the control cage 210 instead of its geometrically refined surfaces 230 and 240.

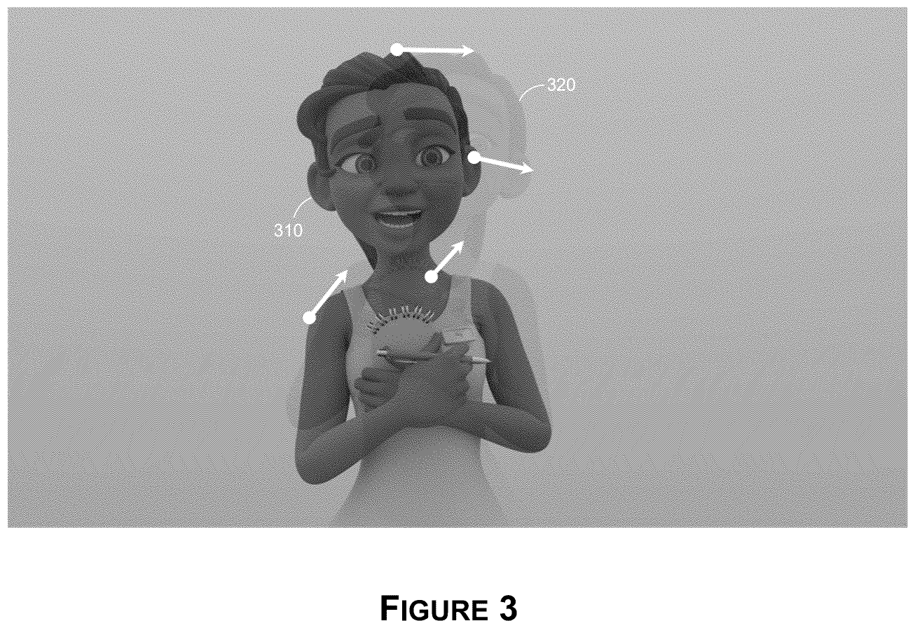

There are a variety of possible ways to compute motion vectors using parametric locations on the limit surface. In some embodiments (e.g., instead of computing motion vectors for each vertex of a geometrically refined surface or its corresponding control cage), the motion computation component 175 may compute motion vectors in screen space. More specifically, the motion computation component 175 may iterate over individual pixels in screen space, computing and storing (e.g., in a buffer) the applicable motion vector for each applicable pixel. Taking ray tracing as an example, the ray tracing component 190 may construct a buffer (e.g., a hit buffer) that represents which surface the ray for each pixel intersected (or a representation that the ray missed any surfaces in the scene, such as marker, flag, or infinite depth value). Taking rasterization as an example, the rasterization component 170 may construct a buffer (e.g., a depth buffer) that represents the rasterized triangle and its corresponding surface that covered each pixel during rasterization (or a representation that no surface covers the pixel, such as an infinite depth value or background color). As such, the motion computation component 175 may iterate over individual pixels in screen space, look up corresponding values from the applicable buffer, determine whether each pixel intersected (or was covered by a rasterized triangle from) a surface, and if so, look up whether the surface was a parametric surface (or that check may be performed during ray tracing or rasterization and encoded into the applicable buffer). For example, the scene may include some objects that are modeled using a parametric surface and some objects that are not. As such, the motion computation component 175 (or some other component) may look up the metadata of the object the surface belongs to and determine whether the metadata indicates the surface is a parametric surface. If a pixel does not represent or depict a parametric surface (e.g., its ray did not intersect a surface or intersected a nonparametric surface, the pixel was not covered by a surface or was covered by a rasterized triangle from a nonparametric surface), the motion computation component 175 may skip that pixel, compute a motion vector for a nonparametric surface some other way, or record some representation that the pixel does not represent or depict a parametric surface (e.g., a null value). Otherwise, the motion computation component 175 may compute a motion vector for that pixel, as explained in more detail below. FIG. 3 illustrates some example motion vectors in screen space (illustrated as white arrows) representing the motion of a character from their position 310 in a first frame to a subsequent position 320 in a subsequent frame. Computing motion vectors for pixels in 2D screen space frees up computational resources and memory by obviating the need to compute motion vectors for each vertex in 3D space (which would likely waste memory and computation resources anyway, as denoisers typically only use motion vectors for visible micro-triangles).

In some embodiments and/or scenarios the motion computation component 175 may compute motion vectors by reconstructing and comparing 3D locations on the limit surface from frame to frame. This technique may be used to compute the motion of a corresponding point on the limit surface, for example, when a pixel represents or depicts a rendered limit surface without displacement, or when a pixel represents or depicts a rendered displaced surface and the motion of the displaced surface is approximated using the motion of the limit surface. In an example implementation, the ray tracing component 190 or the rasterization component 170 may compute the parametric location on the rendered surface the pixel represents or depicts, and the motion computation component 175 may use the parametric location on the rendered (e.g., limit, displaced) surface to reconstruct an approximation of the corresponding 3D location on the limit surface.

For example, the ray tracing component 190 or the rasterization component 170 may generate or populate a buffer with a representation of the parametric location on the rendered surface expressed as barycentric coordinates within the intersected or rasterized triangle (e.g., indicating the pixel's relative position with respect to the triangle's vertices) and an identifier of the intersected or rasterized triangle (e.g., a face ID or triangle ID). In this example, the motion computation component 175 may reconstruct a corresponding 3D location on the limit surface using those barycentric coordinates. For example, the motion computation component 175 may look up the face ID or triangle ID, map it to a corresponding control cage patch the ray intersection or rasterized pixel belongs to, and look up the parametric (u,v) locations of the patch's vertices (which define the original smooth surface before geometric refinement). The motion computation component 175 may use these locations to recalculate the parametric (u,v) locations of the micro-vertices of a corresponding triangle from the geometric refined surface, and may interpolate using the locations of the micro-vertices and the cached barycentric coordinates of the hit point or rasterized pixel to approximate the parametric location on the limit surface. The motion computation component 175 may evaluate the applicable parametric function at the parametric location on the limit surface to reconstruct an approximation of the corresponding 3D location on the limit surface using the locations of the corresponding control points on the control cage from the current frame. The motion computation component 175 may cache a representation of the parametric location on the limit surface corresponding to each applicable pixel (for use in a subsequent frame). For example, the motion computation component 175 may generate or populate a buffer that stores one or more values for each pixel, such as value that indicates there is no geometry visible, or if there is geometry visible, the ID of the object (e.g., mesh) that is visible from the pixel, the face ID for the patch of the limit surface that controls the point on the rendered surface that is visible from the pixel, and the parametric coordinates of the location in the patch corresponding to the 3D location of the rendered surface that is visible from the pixel. Depending on the embodiment, the motion computation component 175 may cache the corresponding 3D location on the limit surface, or the motion computation component 175 may drop the 3D location and reconstruct it in the subsequent frame.

Continuing with an example computation during the current frame, since the applicable object or surface may have moved during animation, the motion computation component 175 may reconstruct the previous 3D location on the limit surface in a previous frame using the cached parametric location on the limit surface corresponding to each applicable pixel in the current frame (or the motion computation component 175 may simply look up a cached 3D location from the previous frame). Taking reconstruction of the previous 3D location on the limit surface as an example, the motion computation component 175 may look up the parametric location on the limit surface (e.g., the parametric coordinates) for an individual pixel (which should be fixed from frame to frame), look up the previous cached locations of the corresponding control points on the control cage from the previous frame, and evaluate the applicable parametric function at the parametric location on the limit surface using the previous cached locations of the corresponding control points to reconstruct an approximation of the previous 3D location on the limit surface for that pixel.

As such, the motion computation component 175 may use the previous and current 3D locations on the limit surface to compute a motion vector for that pixel. For example, the motion computation component 175 may use the current camera configuration (e.g., representing camera parameters such as position and orientation in the scene, focal length, principal point) to project the previous and current 3D locations on the limit surface into 2D screen space, compute the difference between the previous and current 3D locations in 2D screen space, and store the resulting 2D motion vector for that pixel. The motion computation component 175 may repeat the process to compute a motion vector for each applicable pixel.

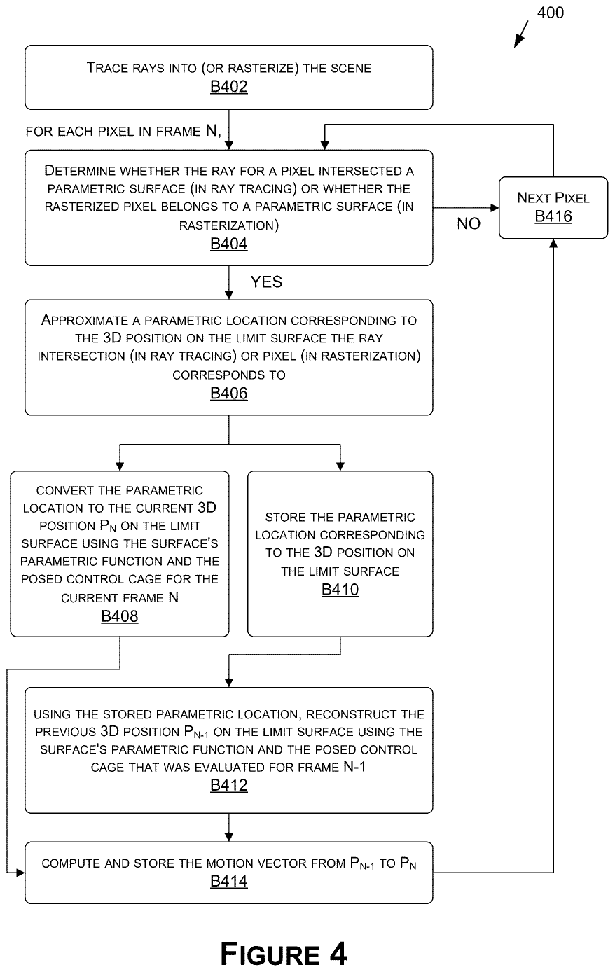

By way of illustration, FIG. 4 is a flow diagram showing a method 400 for computing a motion vector by comparing 3D positions on the limit surface, in accordance with some embodiments of the present disclosure. Generally, FIGS. 4-9 illustrate corresponding methods 400-900, and each block of methods 400-900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a standalone service, a hosted service (standalone or in combination with another hosted service), or a plug-in to another product, to name a few. In addition, the methods are described, by way of example, with respect to the rendering pipeline 100 of FIG. 1. However, these methods may additionally or alternatively be executed by any one system, or any combination of systems, including, but not limited to, those described herein.

In the example illustrated in FIG. 4, the method 400, at block B402, includes tracing rays into (or rasterizing) a scene. For example, with respect to FIG. 1, the ray tracing component 190 or the rasterization component 170 may render a frame using any known technique.

The method 400, starting at block B404, iterates over each pixel in frame N. For any given pixel, at block B404, the method 400 determines whether the ray for the pixel intersected a parametric surface (in ray tracing) or whether the rasterized pixel belongs to a parametric surface (in rasterization). For example, with respect to the rendering pipeline 100 of FIG. 1, the ray tracing component 190 or the rasterization component 170 may construct a buffer (e.g., a hit buffer, G-buffer, depth buffer) that represents whether the ray for the pixel intersected a surface (in ray tracing) or whether the rasterized pixel belongs to a surface. As such, the motion computation component 175 may look up a corresponding value from the buffer (e.g., depth) and determine whether the value indicates that the ray for the pixel intersected a surface or whether the rasterized pixel belongs to a surface. If the ray did not intersect a surface or the rasterized pixel does not belong to a parametric surface (e.g., the depth value was infinite or the buffer held a no-hit marker for the pixel), the method 400 may advance to block B416, which advances to the next pixel and returns to block B404 until there are no more pixels remaining. If the ray did intersect a surface or the rasterized pixel belongs to a surface, the motion computation component 175 may look up a cached identifier of the surface and look up the surface's metadata to determine whether the surface was a parametric surface (or the motion computation component 175 may look up a cached representation of whether the whether the surface was a parametric surface). If not, the method 400 may advance to block B416, which advances to the next pixel and returns to block B404 (or may compute a motion vector for nonparametric surfaces, advance to the next pixel, and return to block B404).

If the ray did intersect a parametric surface or the rasterized pixel belongs to a parametric surface, the method 400 advances to block B406, which approximates a parametric location corresponding to the 3D position on the limit surface the ray intersection or pixel corresponds to. For example, with respect to the rendering pipeline 100 of FIG. 1, the ray tracing component 190 or the rasterization component 170 may compute the parametric location within a triangle on the rendered surface the pixel represents or depicts, and the motion computation component 175 may convert the parametric location within that triangle on the rendered surface to a parametric location within a corresponding patch of the limit surface.

The method 400, at block B408, includes converting the parametric location on the limit surface to the current 3D position on the limit surface using the surface's parametric function and the posed control cage for the current frame N. For example, with respect to the rendering pipeline 100 of FIG. 1, the motion computation component 175 may evaluate the applicable parametric function at the parametric location on the limit surface to reconstruct an approximation of the corresponding 3D location on the limit surface using the locations of the corresponding control points on the posed control cage from the current frame.

The method 400, at block B410, includes storing the parametric location corresponding to the 3D position on the limit surface. For example, with respect to the rendering pipeline 100 of FIG. 1, the motion computation component 175 may cache a representation of the parametric location on the limit surface corresponding to each applicable pixel (for use in a subsequent frame). For example, the motion computation component 175 may store an identifier of the applicable object (e.g., mesh) or surface, an identifier of a corresponding patch, and the parametric location within the patch for each applicable pixel.

The method 400, at block B412, includes using the stored parametric location to reconstruct the previous 3D position on the limit surface using the surface's parametric function and the posed control cage that was evaluated for the previous frame N-1. For example, with respect to the rendering pipeline 100 of FIG. 1, the motion computation component 175 may look up the parametric location on the limit surface for an individual pixel (which should be fixed from frame to frame), look up the previous cached locations of the corresponding control points on the posed control cage from the previous frame, and evaluate the applicable parametric function at the parametric location on the limit surface using the previous cached locations of the corresponding control points to reconstruct an approximation of the previous 3D location on the limit surface for that pixel.

The method 400, at block B414, includes computing and storing the motion vector from the previous 3D position to the current 3D position on the limit surface. For example, with respect to the rendering pipeline 100 of FIG. 1, the motion computation component 175 may use the current camera configuration (e.g., representing camera parameters such as position and orientation in the scene, focal length, principal point) to project the previous and current 3D locations on the limit surface into 2D screen space, compute the difference between the previous and current 3D locations in 2D screen space, and store the resulting 2D motion vector for that pixel.

As such, the method 400 advances to block B416, which advances to the next pixel and returns to block B404 (until there are no more pixels remaining).

Returning now to FIG. 1, in some embodiments with objects or scenes with displaced surfaces, the motion computation component 175 may compute motion vectors by comparing 3D locations on the rendered (displaced) surface or by comparing corresponding 3D locations on the limit surface, and may compute displacement using the applicable displacement function (e.g., a displacement map, texture, procedural math function, some combination thereof such as one implemented using a graph of computational nodes) or by measuring or deriving it from approximated locations on the displaced and limit surfaces.

Taking comparison of 3D locations on a displaced surface (in screen space) and reconstruction of displacement as an example, for a given pixel, the motion computation component 175 may calculate the current 3D location on the displaced surface (e.g., reconstruct it using the cached depth under the pixel and the camera parameters of the current camera), reconstruct the current 3D location on the limit surface from the cached parametric location on the limit surface, reconstruct displacement as the difference between the current 3D locations on the displaced and limit surfaces, reconstruct the previous 3D location on the limit surface using the cached parametric location on the limit surface, apply the reconstructed displacement to reconstruct the previous 3D location on the displaced surface, and compare the current and previous 3D locations on the displaced surface.

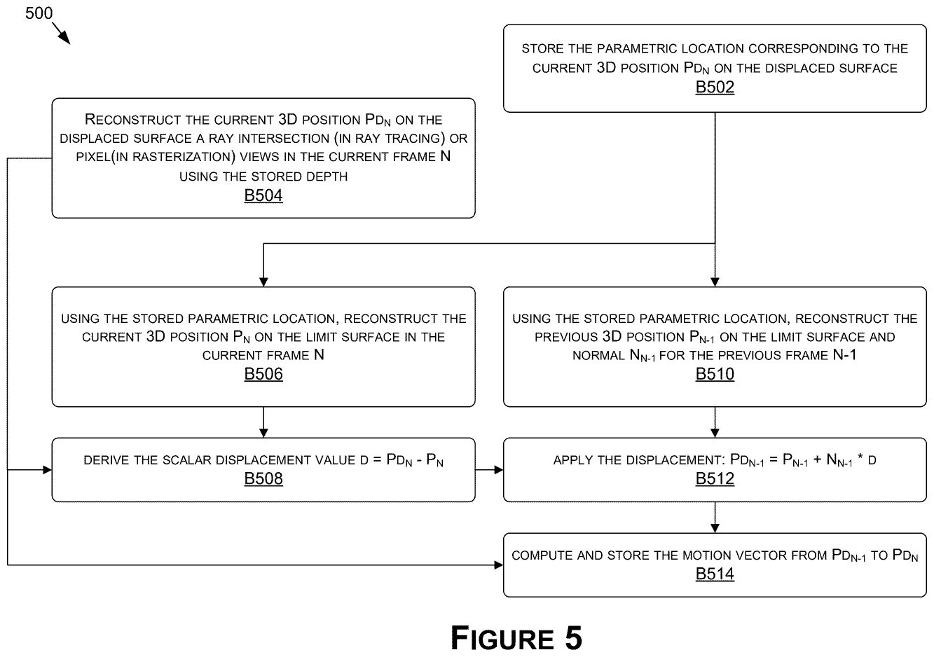

By way of illustration, FIG. 5 is a flow diagram showing a method 500 for computing a motion vector by comparing a current 3D position on a displaced surface to a previous 3D position on the displaced surface reconstructed using derived displacement, in accordance with some embodiments of the present disclosure. The method 500 may represent an alternate path that follows block B406 of method 400, which approximates the parametric location on the limit surface corresponding to the 3D location on the rendered surface represented or depicted by a given pixel. The method 500, at block B502, includes storing the parametric location on the limit surface corresponding to the current 3D position on the rendered (displaced) surface. For example, with respect to the rendering pipeline 100 of FIG. 1, the motion computation component 175 may store an identifier of the applicable object (e.g., mesh) or surface, an identifier of a corresponding patch, and the parametric location within the patch for each applicable pixel.

The method 500, at block B504, includes reconstructing the current 3D position on the displaced surface a ray intersection or rasterized pixel represents or depicts in the current frame using the stored depth under the pixel. For example, with respect to the rendering pipeline 100 of FIG. 1, the ray tracing component 190 or the rasterization component 170 may construct a buffer (e.g., a hit buffer, G-buffer, depth buffer) that stores a representation of the location on the displaced surface each pixel represents or depicts (e.g., 3D coordinates of the approximated surface point, corresponding parametric coordinates in a patch of the limit surface, depth, etc.). As such, the motion computation component 175 may reconstruct the current 3D position on the displaced surface, for example, by looking up the cached depth value and using the depth value and the current camera parameters to perform a reverse camera projection that maps the pixel and depth value back to the current 3D position in the scene.

The method 500, at block B506, includes using the stored parametric location on the limit surface corresponding to the current 3D position on the displaced surface represented or depicted by the pixel to reconstruct the current 3D position on the limit surface in the current frame. For example, with respect to the rendering pipeline 100 of FIG. 1, the motion computation component 175 may use the stored parametric location to reconstruct the current 3D position on the limit surface using the surface's parametric function and the posed control cage for the current frame N. More specifically, the motion computation component 175 may look up the parametric location on the limit surface for an individual pixel (which should be fixed from frame to frame), and evaluate the applicable parametric function at the parametric location on the limit surface using the current locations of the corresponding control points on the posted control cage to reconstruct an approximation of the current 3D location on the limit surface for that pixel.

The method 500, at block B508, includes deriving the scalar displacement value as the difference between the current 3D position on the displaced surface and the current 3D position on the limit surface. For example, with respect to the rendering pipeline 100 of FIG. 1, the motion computation component 175 may derive or measure scalar displacement by subtracting the current 3D position on the limit surface from the current 3D position on the displaced surface.

The method 500, at block B510, includes using the stored parametric location of the limit surface corresponding to the current 3D position on the displaced surface represented or depicted by the pixel to reconstruct the previous 3D position on the limit surface and the surface normal at that position for the previous frame. For example, with respect to the rendering pipeline 100 of FIG. 1, the motion computation component 175 may use the stored parametric location to reconstruct the previous 3D position on the limit surface using the surface's parametric function and the posed control cage that was evaluated for the previous frame N-1. For example, the motion computation component 175 may look up the parametric location on the limit surface for an individual pixel (which should be fixed from frame to frame), look up the previous cached locations of the corresponding control points on the posed control cage from the previous frame, and evaluate the applicable parametric function at the parametric location on the limit surface using the previous cached locations of the corresponding control points to reconstruct an approximation of the previous 3D location on the limit surface for that pixel. The motion computation component 175 may use the derivatives of the parametric function (e.g., tangent vectors) evaluated at that parametric location using the previous 3D locations of the corresponding control points to derive the surface normal (e.g., by taking the cross product of the partial derivatives).

The method 500, at block B512, includes applying the derived scalar displacement to the reconstructed previous 3D position of the limit surface along the surface normal to reconstruct the previous 3D location on the displaced surface. For example, with respect to the rendering pipeline 100 of FIG. 1, the motion computation component 175 may apply the derived scalar displacement by adding it to the reconstructed previous 3D position of the limit surface along the surface normal.

The method 500, at block B514, includes computing and storing the motion vector from the previous 3D position to the current 3D position on the displaced surface. For example, with respect to the rendering pipeline 100 of FIG. 1, the motion computation component 175 may use the current camera parameters to project the previous and current 3D locations on the displaced surface into 2D screen space, compute the difference between the previous and current 3D locations in 2D screen space, and store the resulting 2D motion vector for that pixel.

As such, the method 500 may return to block B416 of the method 400 of FIG. 4, which advances to the next pixel (e.g., starting over at block B404 of method 400, followed by block B502 of FIG. 5), until there are no more pixels remaining.

Taking comparison of 3D locations on a displaced surface (in screen space) and calculation of displacement using a displacement function as an example, for a given pixel, the motion computation component 175 may calculate the current 3D location on the displaced surface (e.g., reconstruct it from cached depth and the current camera parameters), reconstruct the previous 3D location on the limit surface from the cached parametric location on the limit surface, convert the previous 3D location on the limit surface to the previous 3D location on the displaced surface using the displacement function, and compare the current and previous 3D locations on the displaced surface.

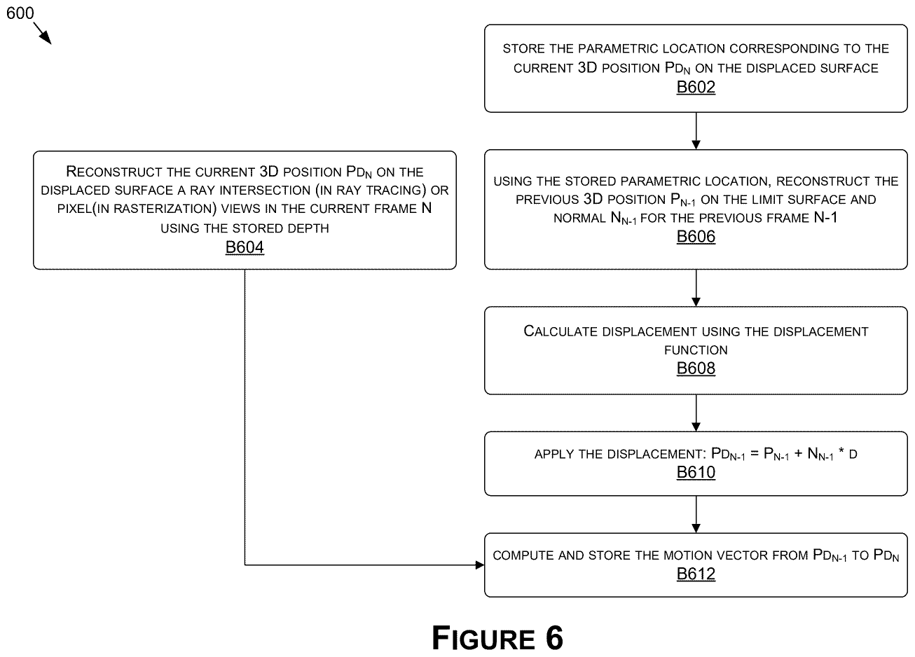

By way of illustration, FIG. 6 is a flow diagram showing a method 600 for computing a motion vector by comparing a current 3D position on a displaced surface to a previous 3D position on the displaced surface reconstructed using a displacement function, in accordance with some embodiments of the present disclosure. The method 600 may represent an alternate path that follows block B406 of method 400, which approximates the parametric location on the limit surface corresponding to the 3D location on the rendered surface represented or depicted by a given pixel. The method 600, at block B602, includes storing the parametric location on the limit surface corresponding to the current 3D position on the rendered (displaced) surface. For example, with respect to the rendering pipeline 100 of FIG. 1, the motion computation component 175 may store an identifier of the applicable object (e.g., mesh) or surface, an identifier of a corresponding patch, and the parametric location within the patch for each applicable pixel.

The method 600, at block B604, includes reconstructing the current 3D position on the displaced surface a ray intersection or rasterized pixel represents or depicts in the current frame using the stored depth under the pixel. For example, with respect to the rendering pipeline 100 of FIG. 1, the ray tracing component 190 or the rasterization component 170 may construct a buffer (e.g., a hit buffer, G-buffer, depth buffer) that stores a representation of the location on the displaced surface each pixel represents or depicts (e.g., 3D coordinates of the approximated surface point, corresponding parametric coordinates in a patch of the limit surface, depth or hit position in 3D space, etc.). As such, the motion computation component 175 may reconstruct the current 3D position on the displaced surface, for example, by looking up the cached depth value and using the depth value and the current camera parameters to perform a reverse camera projection that maps the pixel and depth value back to the current 3D position in the scene.

The method 600, at block B606, includes using the stored parametric location of the limit surface corresponding to the current 3D position on the displaced surface represented or depicted by the pixel to reconstruct the previous 3D position on the limit surface and the surface normal at that position for the previous frame. For example, with respect to the rendering pipeline 100 of FIG. 1, the motion computation component 175 may use the stored parametric location to reconstruct the previous 3D position on the limit surface using the surface's parametric function and the posed control cage that was evaluated for the previous frame N-1. For example, the motion computation component 175 may look up the parametric location on the limit surface for an individual pixel (which should be fixed from frame to frame), look up the previous cached locations of the corresponding control points on the posed control cage from the previous frame, and evaluate the applicable parametric function at the parametric location on the limit surface using the previous cached locations of the corresponding control points to reconstruct an approximation of the previous 3D location on the limit surface for that pixel. The motion computation component 175 may use the derivatives of the parametric function (e.g., tangent vectors) evaluated at that parametric location using the previous 3D locations of the corresponding control points to derive the surface normal (e.g., by taking the cross product of the partial derivatives).

The method 600, at block B608, includes calculating displacement at the parametric location of the limit surface using the displacement function. For example, with respect to the rendering pipeline 100 of FIG. 1, the motion computation component 175 may evaluate the applicable displacement function (e.g., a texture) at the parametric location of the limit surface to look up or compute the displacement at that location.

The method 600, at block B610, includes applying the displacement to the reconstructed previous 3D position of the limit surface along the surface normal to reconstruct the previous 3D location on the displaced surface. For example, with respect to the rendering pipeline 100 of FIG. 1, the motion computation component 175 may apply the derived scalar displacement by adding it to the reconstructed previous 3D position of the limit surface along the surface normal.

The method 600, at block B612, includes computing and storing the motion vector from the previous 3D position to the current 3D position on the displaced surface. For example, with respect to the rendering pipeline 100 of FIG. 1, the motion computation component 175 may use the current camera parameters to project the previous and current 3D locations on the displaced surface into 2D screen space, compute the difference between the previous and current 3D locations in 2D screen space, and store the resulting 2D motion vector for that pixel.

As such, the method 600 may return to block B416 of the method 400 of FIG. 4, which advances to the next pixel (e.g., starting over at block B404 of method 400, followed by block B602 of FIG. 6), until there are no more pixels remaining.

In another example involving comparison of 3D locations on a displaced surface (in screen space) and calculation of displacement using a displacement function, for a given pixel, the motion computation component 175 may reconstruct the current 3D location on the limit surface from the cached parametric location on the limit surface, convert the current 3D location on the limit surface to the current 3D location on the rendered surface using displacement calculated using the displacement function, reconstruct the previous 3D location on the limit surface from the cached parametric location on the limit surface, convert the previous 3D location on the limit surface to the previous 3D location on the displaced surface using the calculated displacement, and compare the current and previous 3D locations on the displaced surface.

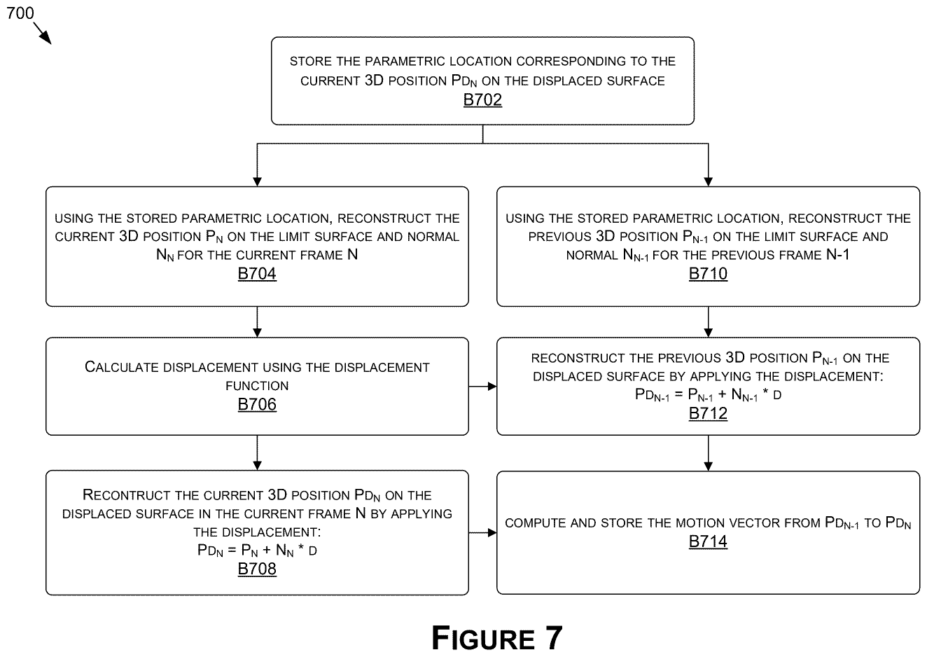

By way of illustration, FIG. 7 is a flow diagram showing a method 700 for computing a motion vector by comparing current and previous 3D positions on a displaced surface reconstructed using a displacement function, in accordance with some embodiments of the present disclosure. The method 700 may represent an alternate path that follows block B406 of method 400, which approximates the parametric location on the limit surface corresponding to the 3D location on the rendered surface represented or depicted by a given pixel. The method 700, at block B702, includes storing the parametric location on the limit surface corresponding to the current 3D position on the rendered (displaced) surface. For example, with respect to the rendering pipeline 100 of FIG. 1, the motion computation component 175 may store an identifier of the applicable object (e.g., mesh) or surface, an identifier of a corresponding patch, and the parametric location within the patch for each applicable pixel.

The method 700, at block B704, includes using the stored parametric location on the limit surface corresponding to the current 3D position on the displaced surface represented or depicted by the pixel to reconstruct the current 3D position on the limit surface and the surface normal for the current frame. For example, with respect to the rendering pipeline 100 of FIG. 1, the motion computation component 175 may use the stored parametric location to reconstruct the current 3D position on the limit surface using the surface's parametric function and the posed control cage for the current frame N. More specifically, the motion computation component 175 may look up the parametric location on the limit surface for an individual pixel (which should be fixed from frame to frame), evaluate the applicable parametric function at the parametric location on the limit surface using the current locations of the corresponding control points on the posted control cage to reconstruct an approximation of the current 3D location on the limit surface for that pixel, and may use the derivatives of the parametric function (e.g., tangent vectors) evaluated at that parametric location using the current 3D locations of the corresponding control points to derive the surface normal (e.g., by taking the cross product of the partial derivatives).

The method 700, at block B706, includes calculating displacement at the parametric location of the limit surface using the displacement function. For example, with respect to the rendering pipeline 100 of FIG. 1, the motion computation component 175 may evaluate the applicable displacement function at the parametric location of the limit surface to look up or compute the displacement at that location.

The method 700, at block B708, includes reconstructing the current 3D position on the displaced surface in the current frame by removing the calculated displacement from the current 3D position on the limit surface. For example, with respect to the rendering pipeline 100 of FIG. 1, the motion computation component 175 may apply the displacement by adding it to the reconstructed current 3D position of the limit surface along the surface normal.

The method 700, at block B710, includes using the stored parametric location of the limit surface corresponding to the current 3D position on the displaced surface represented or depicted by the pixel to reconstruct the previous 3D position on the limit surface and the surface normal at that position for the previous frame. For example, with respect to the rendering pipeline 100 of FIG. 1, the motion computation component 175 may use the stored parametric location to reconstruct the previous 3D position on the limit surface using the surface's parametric function and the posed control cage that was evaluated for the previous frame N-1. For example, the motion computation component 175 may look up the parametric location on the limit surface for an individual pixel (which should be fixed from frame to frame), look up the previous cached locations of the corresponding control points on the posed control cage from the previous frame, evaluate the applicable parametric function at the parametric location on the limit surface using the previous cached locations of the corresponding control points to reconstruct an approximation of the previous 3D location on the limit surface for that pixel, and use the derivatives of the parametric function (e.g., tangent vectors) evaluated at that parametric location using the previous 3D locations of the corresponding control points to derive the surface normal (e.g., by taking the cross product of the partial derivatives).

The method 700, at block B712, includes reconstructing the previous 3D position on the displaced surface by applying the calculated displacement to the reconstructed previous 3D position of the limit surface along the surface normal. For example, with respect to the rendering pipeline 100 of FIG. 1, the motion computation component 175 may apply the calculated displacement value by adding it to the reconstructed previous 3D position of the limit surface along the surface normal.

The method 700, at block B714, includes computing and storing the motion vector from the previous 3D position to the current 3D position on the displaced surface. For example, with respect to the rendering pipeline 100 of FIG. 1, the motion computation component 175 may use the current camera parameters to project the previous and current 3D locations on the displaced surface into 2D screen space, compute the difference between the previous and current 3D locations in 2D screen space, and store the resulting 2D motion vector for that pixel.

As such, the method 700 may return to block B416 of the method 400 of FIG. 4, which advances to the next pixel (e.g., starting over at block B404 of method 400, followed by block B702 of FIG. 7), until there are no more pixels remaining.

Taking comparison of 3D locations on a limit surface (in screen space) and calculation of displacement using a displacement function as an example, for a given pixel, the motion computation component 175 may calculate the current 3D location on the displaced surface (e.g., reconstruct it from the cached depth and the camera parameters of the current camera), convert the current 3D location on the displaced surface to the current 3D location on the limit surface using the displacement function, reconstruct the previous 3D location on the limit surface from the cached parametric location on the limit surface, and compare the current and previous 3D locations on the limit surface.

As such, and returning to FIG. 1, the motion computation component 175 may compute a motion vector for each applicable pixel, and may store the motion vectors in a buffer. Accordingly, the denoising component 185 may use the motion vectors to denoise the rendered frame (e.g., image) using any known technique. For example, the denoising component 185 may use any known spatial accumulation and/or temporal accumulation (spatio-temporal) technique, reusing data from neighboring pixels (spatial) and/or previous frames (temporal) to smooth out noise. The motion vectors may effectively track how each pixel (rendered surface) moves from one frame to the next (due to camera or object motion), so the denoising component 185 may reproject pixels from previous frames into the current frame and accumulate pixel values over time, effectively increasing the sample count per pixel and reducing noise. Accordingly, the rendering pipeline 100 may provide the denoised frame for presentation, apply any known post-processing effect, combine the rendered frame with other data (e.g., as part of a video), or otherwise make the denoised frame available for any suitable downstream use.

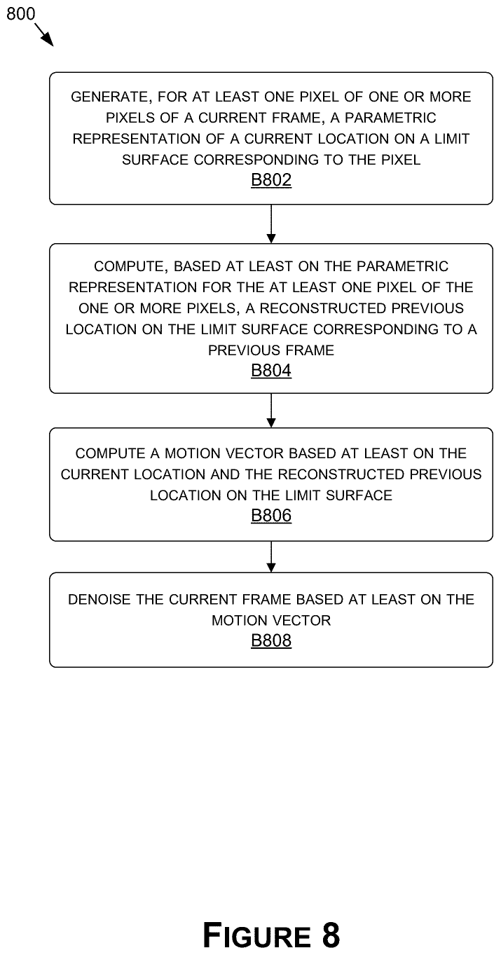

Turning now to FIG. 8 is a flow diagram showing a method 800 for computing a motion vector based at least on a current location and a reconstructed previous location on a limit surface, in accordance with some embodiments of the present disclosure. The method 800, at block B802, includes generating, for at least one pixel of one or more pixels of a current frame, a parametric representation of a current location on a limit surface corresponding to the pixel. For example, with respect to the rendering pipeline 100 of FIG. 1, the ray tracing component 190 or the rasterization component 170 may compute the parametric location within a triangle on a rendered (e.g., limit, displaced) surface the pixel represents or depicts, and the motion computation component 175 may convert the parametric location within that triangle on the rendered surface to a parametric location within a corresponding patch of the limit surface.

The method 800, at block B804, includes computing, based at least on the parametric representation for the at least one pixel of the one or more pixels, a reconstructed previous location on the limit surface corresponding to a previous frame. For example, with respect to the rendering pipeline 100 of FIG. 1, the motion computation component 175 may look up the parametric location on the limit surface for an individual pixel (which should be fixed from frame to frame), look up the previous cached locations of the corresponding control points on the posed control cage from the previous frame, and evaluate the applicable parametric function at the parametric location on the limit surface using the previous cached locations of the corresponding control points to reconstruct an approximation of the previous 3D location on the limit surface for that pixel.

The method 800, at block B806, includes computing a motion vector based at least on the current location and the reconstructed previous location on the limit surface. For example, with respect to the rendering pipeline 100 of FIG. 1, the motion computation component 175 may evaluate the applicable parametric function at the parametric location on the limit surface to reconstruct an approximation of the corresponding 3D location on the limit surface using the locations of the corresponding control points on the posed control cage from the current frame. As such, the motion computation component 175 may use the current camera configuration (e.g., representing camera parameters such as position and orientation in the scene, focal length, principal point) to project the previous and current 3D locations on the limit surface into 2D screen space, compute the difference between the previous and current 3D locations in 2D screen space, and store the resulting 2D motion vector for that pixel.

The method 800, at block B808, includes denoising the current frame based at least on the motion vector. For example, with respect to the rendering pipeline 100 of FIG. 1, the denoising component 185 may use the motion vectors to denoise the rendered frame (e.g., image) using any known technique.

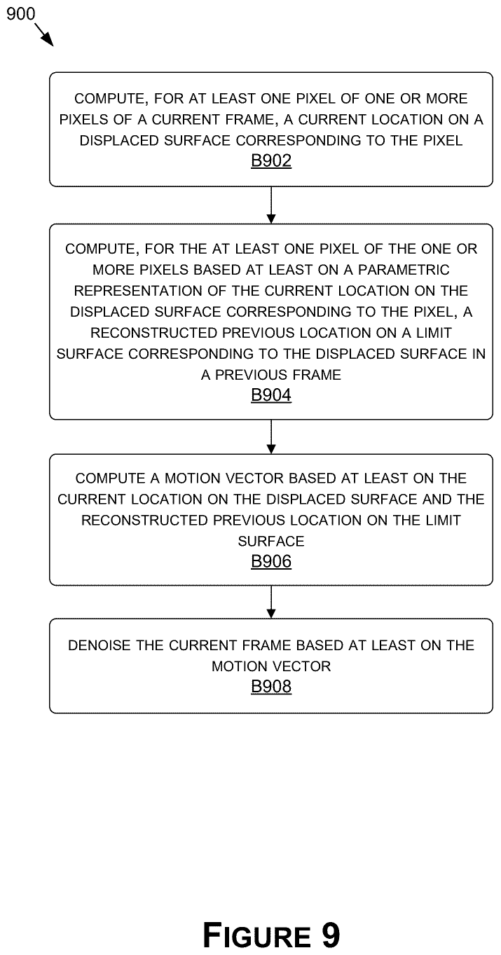

FIG. 9 is a flow diagram showing a method for computing a motion vector based at least on a current location on a displaced surface and a reconstructed previous location on the limit surface, in accordance with some embodiments of the present disclosure. The method 900, at block B902, includes computing, for at least one pixel of one or more pixels of a current frame, a current location on a displaced surface corresponding to the pixel. For example, with respect to the rendering pipeline 100 of FIG. 1, the ray tracing component 190 or the rasterization component 170 may construct a buffer (e.g., a hit buffer, G-buffer, depth buffer) that stores a representation of the location on the displaced surface each pixel represents or depicts (e.g., 3D coordinates of the approximated surface point, corresponding parametric coordinates in a patch of the limit surface, depth, etc.). As such, the motion computation component 175 may reconstruct the current 3D position on the displaced surface, for example, by looking up the cached depth value and using the depth value and the current camera parameters to perform a reverse camera projection that maps the pixel and depth value back to the current 3D position in the scene.

In another example, the motion computation component 175 may use the stored parametric location to reconstruct the current 3D position on the limit surface using the surface's parametric function and the posed control cage for the current frame N, evaluate the applicable displacement function (e.g., a texture) at the parametric location of the limit surface to look up or compute the displacement at that location, and reconstruct the current 3D position on the displaced surface in the current frame by removing the calculated displacement from the current 3D position on the limit surface.

The method 900, at block B904, includes computing, for the at least one pixel of the one or more pixels based at least on a parametric representation of the current location on the displaced surface corresponding to the pixel, a reconstructed previous location on a limit surface corresponding to the displaced surface in a previous frame. For example, with respect to the rendering pipeline 100 of FIG. 1, the motion computation component 175 may use the stored parametric location of the limit surface corresponding to the current 3D position on the displaced surface viewed by the pixel to reconstruct the previous 3D position on the limit surface and the surface normal at that position for the previous frame.

The method 900, at block B906, includes computing a motion vector based at least on the current location on the displaced surface and the reconstructed previous location on the limit surface. For example, with respect to the rendering pipeline 100 of FIG. 1, the motion computation component 175 may derive or measure scalar displacement as the difference between the current 3D position on the displaced surface and the current 3D position on the limit surface, apply the derived scalar displacement to the reconstructed previous 3D position of the limit surface along the surface normal to reconstruct the previous 3D location on the displaced surface, and compute and store the motion vector from the previous 3D position to the current 3D position on the displaced surface in screen space.

In another example, the motion computation component 175 the motion computation component 175 may evaluate the applicable displacement function (e.g., a displacement, texture, procedural math function) at the parametric location of the limit surface to look up or compute the displacement at that location, apply the displacement to the reconstructed previous 3D position of the limit surface along the surface normal to reconstruct the previous 3D location on the displaced surface, and compute and store the motion vector from the previous 3D position to the current 3D position on the displaced surface in screen space.

The method 900, at block B908, includes denoising the current frame based at least on the motion vector. For example, with respect to the rendering pipeline 100 of FIG. 1, the denoising component 185 may use the motion vectors to denoise the rendered frame (e.g., image) using any known technique.

### Example Applications

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle types, such as in connection with simulation, perception system development, or synthetic data generation for training purposes. Further, the systems and methods described herein may be used for a variety of purposes, by way of example and without limitation, for synthetic data generation, model training, augmented reality, virtual reality, mixed reality, robotics, security and surveillance, simulation and digital twinning, autonomous or semi-autonomous machine applications, deep learning, environment simulation, object or actor simulation and/or digital twinning, light transport simulation (e.g., ray-tracing, path tracing, etc.), collaborative content creation for 3D assets (e.g., NVIDIA's Omniverse), cloud computing, and/or any other suitable applications.

Disclosed embodiments may be comprised in a variety of different systems such as automotive systems (e.g., a control system for an autonomous or semi-autonomous machine, a perception system for an autonomous or semi-autonomous machine, etc.), systems implemented using a robot, aerial systems, medial systems, boating systems, smart area monitoring systems, systems for performing deep learning operations, systems for performing simulation operations, systems for performing digital twin operations, systems using or deploying one or more inference microservices, systems for performing synthetic data generation operations, systems implemented at least partially in a data center, systems for performing light transport simulation, systems for performing collaborative content creation for 3D assets, systems for performing generative AI operations, systems implemented at least partially using cloud computing resources (e.g., for remote rendering or simulation), and/or other types of systems.

In some embodiments, the systems and methods described herein may be used to generate a simulation environment (e.g., NVIDIA's DriveSIM, ISAAC Sim, ISAAC Gym, ISAAC Lab, etc.) such as one that uses simulated data (e.g., simulated environmental data and simulated sensor data of simulated sensors of a virtual or simulated vehicle, robot, or machine within the simulated environment). For example, simulated input data (e.g., map data, perception data, ego-motion data, tactile data, and/or any other data described herein) may be used to updated a simulated environment, and visual or simulated machine may perform operations within the simulation environment. These simulated operations may be used to test performance of the underlying algorithms, systems, and/or processes prior to deploying them in the real-world. In some instances, the simulation may be used to generate synthetic training data, and the synthetic training data (in addition to or alternatively from real-world data) may then be used or processed to train various models.

In any example, such as where a simulation environment is used for testing, validation, training, etc., the simulation environment and/or associated training data may be rendered or otherwise generated using one or more light transport simulation algorithms—such as one or more ray-tracing, path-tracing algorithms, and/or denoising algorithms. Where light transport simulation is used, the simulation system may employ one or more dedicated ray-tracing hardware accelerators and/or processors (e.g., NVIDIA's RTX, or another real-time ray-tracing GPU, such as those that include one or more ray tracing (RT) cores) optimized for performing real-time or near real-time light transport simulation operations in conjunction with one or more other processors of the system (e.g., GPUs, CPUs, accelerators, etc.). In some embodiments, the simulation environment and/or one or more objects, features, or components thereof may be generated or managed within a three-dimensional (3D) content collaboration platform (e.g., NVIDIA's OMNIVERSE) that may be optimized or suitable for industrial digitalization, generative physical artificial intelligence, and/or other use cases, applications, and/or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation (e.g., using NVIDIA's PhysX software developer kit (SDK)), in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, and/or testing AI systems—such as systems for testing, validating, training (e.g., machine learning models, neural networks, etc.), and/or other tasks related to automobiles, robots, other machine types, and/or other systems and applications. In some examples, the simulation environment may include a digital twin of a real environment, such as a digital twin of a specific stretch of roadway, a warehouse, a data center, an airport, a geographic area, a marine area, and/or any other real environment where autonomous or semi-autonomous vehicles or machines may operate.

### Parallel Processing Architecture

FIG. 10 illustrates a parallel processing unit (PPU) 1000, in accordance with an embodiment. In an embodiment, the PPU 1000 is a multi-threaded processor that is implemented on one or more integrated circuit devices. The PPU 1000 is a latency hiding architecture designed to process many threads in parallel. A thread (e.g., a thread of execution) is an instantiation of a set of instructions configured to be executed by the PPU 1000. In an embodiment, the PPU 1000 is a graphics processing unit (GPU) configured to implement a graphics rendering pipeline for processing three-dimensional (3D) graphics data in order to generate two-dimensional (2D) image data for display on a display device such as a liquid crystal display (LCD) device. Additionally or alternatively, the PPU 1000 may be utilized for general-purpose computations. While certain embodiments focus on features of the example parallel processing unit described herein, this is meant simply as an example, and other processors may be implemented within the scope of the present disclosure.

One or more instances of the PPU 1000 may be configured to accelerate thousands of High-Performance Computing (HPC), data center, and/or machine learning applications. The PPU 1000 may be configured to accelerate numerous deep learning systems and/or other applications, such as autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, to name a few examples.

As shown in FIG. 10, the PPU 1000 includes an Input/Output (I/O) unit 1005, a front-end unit 1015, a scheduler unit 1020, a work distribution unit 1025, a hub 1030, a crossbar (Xbar) 1070, one or more general processing clusters (GPCs) 1050, and one or more partition units 1080. The PPU 1000 may be connected to a host processor or other PPUs 1000 via one or more high-speed NVLink 1010 interconnect. The PPU 1000 may be connected to a host processor or other peripheral devices via an interconnect 1002. The PPU 1000 may also be connected to a local memory comprising any number of memory devices (e.g., memory 1004). In an embodiment, the local memory may comprise a number of dynamic random-access memory (DRAM) devices. The DRAM devices may be configured as a high-bandwidth memory (HBM) subsystem, with multiple DRAM dies stacked within each device.

The NVLink 1010 interconnect enables systems to scale and include one or more PPUs 1000 combined with one or more CPUs, supports cache coherence between the PPUs 1000 and CPUs, and CPU mastering. Data and/or commands may be transmitted by the NVLink 1010 through the hub 1030 to/from other units of the PPU 1000 such as one or more copy engines, a video encoder, a video decoder, a power management unit, etc. (not explicitly shown). The NVLink 1010 is described in more detail in conjunction with FIG. 12B.

The I/O unit 1005 is configured to transmit and receive communications (e.g., commands, data, etc.) from a host processor (not shown) over the interconnect 1002. The I/O unit 1005 may communicate with the host processor directly via the interconnect 1002 and/or through one or more intermediate devices such as a memory bridge. In an embodiment, the I/O unit 1005 may communicate with one or more other processors such as one or more PPUs 1000 via the interconnect 1002. In an embodiment, the I/O unit 1005 implements a Peripheral Component Interconnect Express (PCIe) interface for communications over a PCIe bus and the interconnect 1002 is a PCIe bus. In alternative embodiments, the I/O unit 1005 may implement other types of well-known interfaces for communicating with external devices.

The I/O unit 1005 decodes packets received via the interconnect 1002. In an embodiment, the packets represent commands configured to cause the PPU 1000 to perform various operations. The I/O unit 1005 transmits the decoded commands to various other units of the PPU 1000 as the commands may specify. For example, some commands may be transmitted to the front-end unit 1015. Other commands may additionally or alternatively be transmitted to the hub 1030 or other units of the PPU 1000 such as one or more copy engines, a video encoder, a video decoder, a power management unit, etc. (not explicitly shown). In other words, the I/O unit 1005 may route communications between and among the various logical units of the PPU 1000.

In an embodiment, a program executed by the host processor may encode a command stream in a buffer that provides workloads to the PPU 1000 for processing. A workload may comprise several instructions and data to be processed by those instructions. The buffer is a region in a memory that is accessible (e.g., read/write) by both the host processor and the PPU 1000. For example, the I/O unit 1005 may be configured to access the buffer in a system memory connected to the interconnect 1002 via memory requests transmitted over the interconnect 1002. In an embodiment, the host processor writes the command stream to the buffer and then transmits a pointer to the start of the command stream to the PPU 1000. The front-end unit 1015 may receive pointers to one or more command streams. As such, the front-end unit 1015 may manage the one or more streams, reading commands from the streams and forwarding commands to the various units of the PPU 1000.

The front-end unit 1015 may be coupled to a scheduler unit 1020 that configures the various GPCs 1050 to process tasks defined by the one or more streams. The scheduler unit 1020 is configured to track state information related to the various tasks managed by the scheduler unit 1020. The state may indicate which GPC 1050 a task is assigned to, whether the task is active or inactive, a priority level associated with the task, and so forth. The scheduler unit 1020 manages the execution of a plurality of tasks on the one or more GPCs 1050.

Continuing with the embodiment illustrated in FIG. 10, the scheduler unit 1020 may be coupled to a work distribution unit 1025 that is configured to dispatch tasks for execution on the GPCs 1050. The work distribution unit 1025 may track a number of scheduled tasks received from the scheduler unit 1020. In an embodiment, the work distribution unit 1025 manages a pending task pool and an active task pool for each of the GPCs 1050. The pending task pool may comprise a number of slots (e.g., 32 slots) that contain tasks assigned to be processed by a particular GPC 1050. The active task pool may comprise a number of slots (e.g., 4 slots) for tasks that are actively being processed by the GPCs 1050. As a GPC 1050 finishes the execution of a task, that task may be evicted from the active task pool for the GPC 1050 and one of the other tasks from the pending task pool may be selected and scheduled for execution on the GPC 1050. If an active task has been idle on the GPC 1050, such as while waiting for a data dependency to be resolved, then the active task may be evicted from the GPC 1050 and returned to the pending task pool while another task in the pending task pool is selected and scheduled for execution on the GPC 1050.

The work distribution unit 1025 may communicate with the one or more GPCs 1050 via XBar 1070. The XBar 1070 may comprise an interconnect network that couples many of the units of the PPU 1000 to other units of the PPU 1000. For example, the XBar 1070 may be configured to couple the work distribution unit 1025 to a particular GPC 1050. Although not shown explicitly, one or more other units of the PPU 1000 may also be connected to the XBar 1070 via the hub 1030.

The tasks may be managed by the scheduler unit 1020 and dispatched to a GPC 1050 by the work distribution unit 1025. The GPC 1050 may be configured to process the tasks and generate results. The results may be consumed by other tasks within the GPC 1050, routed to a different GPC 1050 via the XBar 1070, or stored in the memory 1004. The results may be written to the memory 1004 via the partition units 1080, which may implement a memory interface for reading and writing data to/from the memory 1004. The results may be transmitted to another PPU 1000 or CPU via the NVLink 1010. In an embodiment, the PPU 1000 includes a number U of partition units 1080 that is equal to the number of separate and distinct memory 1004 devices coupled to the PPU 1000. A partition unit 1080 will be described in more detail in conjunction with FIG. 11B.

In an embodiment, a host processor executes a driver kernel that implements an application programming interface (API) that enables one or more applications executing on the host processor to schedule operations for execution on the PPU 1000. In an embodiment, multiple compute applications are simultaneously executed by the PPU 1000 and the PPU 1000 provides isolation, quality of service (QoS), and independent address spaces for the multiple compute applications. An application may generate instructions (e.g., API calls) that cause the driver kernel to generate one or more tasks for execution by the PPU 1000. The driver kernel may output tasks to one or more streams being processed by the PPU 1000. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 12A.

FIG. 11A illustrates a GPC 1050 of the PPU 1000 of FIG. 10, in accordance with an embodiment. As shown in FIG. 11A, each GPC 1050 includes a number of hardware units for processing tasks. In an embodiment, each GPC 1050 includes a pipeline manager 1110, a pre-raster operations unit (PROP) 1115, a raster engine 1125, a work distribution crossbar (WDX) 1180, a memory management unit (MMU) 1190, and one or more Data Processing Clusters (DPCs) 1120. It will be appreciated that the GPC 1050 of FIG. 11A may include other hardware units in lieu of or in addition to the units shown in FIG. 11A.

In an embodiment, the operation of the GPC 1050 is controlled by the pipeline manager 1110. The pipeline manager 1110 manages the configuration of the one or more DPCs 1120 for processing tasks allocated to the GPC 1050. In an embodiment, the pipeline manager 1110 may configure at least one of the one or more DPCs 1120 to implement at least a portion of a graphics rendering pipeline. For example, a DPC 1120 may be configured to execute a vertex shader program on the programmable streaming multiprocessor (SM) 1140. The pipeline manager 1110 may also be configured to route packets received from the work distribution unit 1025 to the appropriate logical units within the GPC 1050. For example, some packets may be routed to fixed function hardware units in the PROP 1115 and/or raster engine 1125 while other packets may be routed to the DPCs 1120 for processing by the primitive engine 1135 or the SM 1140. In an embodiment, the pipeline manager 1110 may configure at least one of the one or more DPCs 1120 to implement a neural network model and/or a computing pipeline.

The PROP unit 1115 may be configured to route data generated by the raster engine 1125 and the DPCs 1120 to a Raster Operations (ROP) unit, described in more detail in conjunction with FIG. 11B. In some embodiments, the PROP unit 1115 is configured to perform optimizations for color blending, organize pixel data, perform address translations, and/or other tasks.

The raster engine 1125 includes a number of fixed function hardware units configured to perform various raster operations. In an embodiment, the raster engine 1125 includes a setup engine, a coarse raster engine, a culling engine, a clipping engine, a fine raster engine, and/or a tile coalescing engine. The setup engine may receive transformed vertices and generate plane equations associated with the geometric primitive defined by the vertices. The plane equations may be transmitted to the coarse raster engine to generate coverage information (e.g., an x, y coverage mask for a tile) for the primitive. The output of the coarse raster engine may be transmitted to the culling engine where fragments associated with the primitive that fail a z-test may be culled, and transmitted to a clipping engine where fragments lying outside a viewing frustum may be clipped. Those fragments that survive clipping and culling may be passed to the fine raster engine to generate attributes for the pixel fragments based on the plane equations generated by the setup engine. The output of the raster engine 1125 may comprise fragments to be processed, for example, by a fragment shader implemented within a DPC 1120.

Each DPC 1120 included in the GPC 1050 may include an M-Pipe Controller (MPC) 1130, a primitive engine 1135, and one or more SMs 1140. The MPC 1130 may control the operation of the DPC 1120, routing packets received from the pipeline manager 1110 to the appropriate units in the DPC 1120. For example, packets associated with a vertex may be routed to the primitive engine 1135, which may be configured to fetch vertex attributes associated with the vertex from the memory 1004. In contrast, packets associated with a shader program may be transmitted to the SM 1140.

The SM 1140 comprises a programmable streaming processor that is configured to process tasks represented by a number of threads. Each SM 1140 is multi-threaded and configured to execute a plurality of threads (e.g., 32 threads) from a particular group of threads concurrently. In an embodiment, the SM 1140 implements a SIMD (Single-Instruction, Multiple-Data) architecture where each thread in a group of threads (e.g., a warp) is configured to process a different set of data based on the same set of instructions. All threads in the group of threads execute the same instructions. In another embodiment, the SM 1140 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 1140 will be described in more detail below in conjunction with FIG. 12A.

The MMU 1190 provides an interface between the GPC 1050 and the partition unit 1080. The MMU 1190 may provide translation of virtual addresses into physical addresses, memory protection, and arbitration of memory requests. In an embodiment, the MMU 1190 provides one or more translation lookaside buffers (TLBs) for performing translation of virtual addresses into physical addresses in the memory 1004.

FIG. 11B illustrates a memory partition unit 1080 of the PPU 1000 of FIG. 10, in accordance with an embodiment. As shown in FIG. 11B, the memory partition unit 1080 includes a Raster Operations (ROP) unit 1150, a level two (L2) cache 1160, and a memory interface 1170. The memory interface 1170 is coupled to the memory 1004. Memory interface 1170 may implement 32, 64, 128, 1024-bit data buses, or other types of data buses, for high-speed data transfer. In an embodiment, the PPU 1000 incorporates U memory interfaces 1170, one memory interface 1170 per pair of partition units 1080, where each pair of partition units 1080 is connected to a corresponding memory device (e.g., memory 1004). For example, PPU 1000 may be connected to up to Y memory devices, such as high bandwidth memory stacks or graphics double-data-rate, version 5, synchronous dynamic random-access memory, or other types of persistent storage.

In an embodiment, the memory interface 1170 implements an HBM2 memory interface and Y equals half U. In an embodiment, the HBM2 memory stacks are located on the same physical package as the PPU 1000, providing substantial power and area savings compared with conventional GDDR5 SDRAM systems. In an embodiment, each HBM2 stack includes four memory dies and Y equals 4, with HBM 2 stack including two 128-bit channels per die for a total of 8 channels and a data bus width of 1024 bits.

In an embodiment, the memory 1004 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 1000 process very large datasets and/or run applications for extended periods.

In an embodiment, the PPU 1000 implements a multi-level memory hierarchy. In an embodiment, the memory partition unit 1080 supports a unified memory to provide a single unified virtual address space for CPU and PPU 1000 memory, enabling data sharing between virtual memory systems. In an embodiment, the frequency of accesses by a PPU 1000 to memory located on other processors is traced to ensure that memory pages are moved to the physical memory of the PPU 1000 that is accessing the pages more frequently. In an embodiment, the NVLink 1010 supports address translation services allowing the PPU 1000 to directly access a CPU's page tables and providing full access to CPU memory by the PPU 1000.

In an embodiment, copy engines transfer data between multiple PPUs 1000 or between PPUs 1000 and CPUs. The copy engines may generate page faults for addresses that are not mapped into the page tables. The memory partition unit 1080 may then service the page faults, mapping the addresses into the page table, after which the copy engine may perform the transfer. In a conventional system, memory may be pinned (e.g., non-pageable) for multiple copy engine operations between multiple processors, substantially reducing the available memory. With hardware page faulting, addresses may be passed to the copy engines independent of whether the memory pages are in use, and the copying process may occur seamlessly.

Data from the memory 1004 or other system memory may be fetched by the memory partition unit 1080 and stored in the L2 cache 1160, which is located on-chip and is shared between the various GPCs 1050. As shown, each memory partition unit 1080 includes a portion of the L2 cache 1160 associated with a corresponding memory device (e.g., memory 1004). Lower level caches may be implemented in various units within the GPCs 1050. For example, each of the SMs 1140 may implement a level one (L1) cache. The L1 cache is private memory that is dedicated to a particular SM 1140. Data from the L2 cache 1160 may be fetched and stored in each of the L1 caches for processing in the functional units of the SMs 1140. The L2 cache 1160 is coupled to the memory interface 1170 and the XBar 1070.

The ROP unit 1150 may perform graphics raster operations related to pixel color, such as color compression, pixel blending, and/or the like. The ROP unit 1150 may implements depth testing in conjunction with the raster engine 1125, receiving a depth for a sample location associated with a pixel fragment from the culling engine of the raster engine 1125. The depth may be tested against a corresponding depth in a depth buffer for a sample location associated with the fragment. If the fragment passes the depth test for the sample location, the ROP unit 1150 may update the depth buffer and transmit a result of the depth test to the raster engine 1125. It will be appreciated that the number of partition units 1080 may be different than the number of GPCs 1050 and, therefore, each ROP unit 1150 may be coupled to each of the GPCs 1050. The ROP unit 1150 may track packets received from the different GPCs 1050 and determine to which GPC 1050 a result generated by the ROP unit 1150 is routed through the Xbar 1070. Although the ROP unit 1150 is included within the memory partition unit 1080 in FIG. 11B, in some embodiments, the ROP unit 1150 may be outside of the memory partition unit 1080. For example, the ROP unit 1150 may reside in the GPC 1050 or another unit.

FIG. 12A illustrates the streaming multi-processor 1140 of FIG. 11A, in accordance with an embodiment. As shown in FIG. 12A, the SM 1140 includes an instruction cache 1205, one or more scheduler units 1210, a register file 1220, one or more processing cores 1250, one or more special function units (SFUs) 1252, one or more load/store units (LSUs) 1254, an interconnect network 1280, a shared memory/L1 cache 1270.

As described above, the work distribution unit 1025 dispatches tasks for execution on the GPCs 1050 of the PPU 1000. The tasks are allocated to a particular DPC 1120 within a GPC 1050 and, if the task is associated with a shader program, the task may be allocated to an SM 1140. The scheduler unit 1210 may receive the tasks from the work distribution unit 1025 and manage instruction scheduling for one or more thread blocks assigned to the SM 1140. The scheduler unit 1210 may schedule thread blocks for execution as warps of parallel threads, where each thread block may be allocated at least one warp. In an embodiment, each warp executes 32 threads. The scheduler unit 1210 may manage a plurality of different thread blocks, allocating the warps to the different thread blocks and then dispatching instructions from the plurality of different cooperative groups to the various functional units (e.g., cores 1250, SFUs 1252, and LSUs 1254) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads() function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 1215 may be configured to transmit instructions to one or more of the functional units. In the embodiment, the scheduler unit 1210 includes two dispatch units 1215 that enable two different instructions from the same warp to be dispatched during each clock cycle. In alternative embodiments, each scheduler unit 1210 may include a single dispatch unit 1215 or additional dispatch units 1215.

Each SM 1140 may include a register file 1220 that provides a set of registers for the functional units of the SM 1140. In an embodiment, the register file 1220 is divided between each of the functional units such that each functional unit is allocated a dedicated portion of the register file 1220. In some embodiments, the register file 1220 is divided between the different warps being executed by the SM 1140. The register file 1220 provides temporary storage for operands connected to the data paths of the functional units.

Each SM 1140 may comprise L processing cores 1250. In an embodiment, the SM 1140 includes a large number (e.g., 128, etc.) of distinct processing cores 1250. Each core 1250 may include a fully pipelined, single-precision, double-precision, and/or mixed precision processing unit that includes a floating-point arithmetic logic unit and an integer arithmetic logic unit. In an embodiment, the floating-point arithmetic logic units implement the IEEE 754-2008 standard for floating-point arithmetic. In an embodiment, the cores 1250 include 64 single-precision (32-bit) floating-point cores, 64 integer cores, 32 double-precision (64-bit) floating-point cores, and 8 tensor cores.

Tensor cores configured to perform matrix operations, and, in an embodiment, one or more tensor cores are included in the cores 1250. In particular, the tensor cores may be configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating-point matrices, while the accumulation matrices C and D may be 16-bit floating-point or 32-bit floating-point matrices. Tensor Cores may operate on 16-bit floating-point input data with 32-bit floating-point accumulation. The 16-bit floating-point multiply requires 64 operations and results in a full precision product that is then accumulated using 32-bit floating-point addition with the other intermediate products for a 4×4×4 matrix multiply. In practice, Tensor Cores are often used to perform much larger two-dimensional or higher dimensional matrix operations, built up from these smaller elements. An API, such as CUDA C++ API, may expose specialized matrix load, matrix multiply and accumulate, and/or matrix store operations to efficiently use Tensor Cores from a CUDA-C++ program. At the CUDA level, the warp-level interface may assume 16×16 size matrices spanning all 32 threads of the warp.

Each SM 1140 may comprise M SFUs 1252 that perform special functions (e.g., attribute evaluation, reciprocal square root, and the like). In an embodiment, the SFUs 1252 may include a tree traversal unit configured to traverse a hierarchical tree data structure. In an embodiment, the SFUs 1252 may include texture unit configured to perform texture map filtering operations. In an embodiment, the texture units are configured to load texture maps (e.g., a 2D array of texels) from the memory 1004 and sample the texture maps to produce sampled texture values for use in shader programs executed by the SM 1140. In an embodiment, the texture maps are stored in the shared memory/L1 cache 1270. The texture units may implement texture operations such as filtering operations using mip-maps (e.g., texture maps of varying levels of detail). In an embodiment, each SM 1040 includes two texture units.

Each SM 1140 may comprise N LSUs 1254 that implement load and store operations between the shared memory/L1 cache 1270 and the register file 1220. Each SM 1140 may include an interconnect network 1280 that connects each of the functional units to the register file 1220 and the LSU 1254 to the register file 1220, shared memory/L1 cache 1270. In an embodiment, the interconnect network 1280 is a crossbar that can be configured to connect any of the functional units to any of the registers in the register file 1220 and connect the LSUs 1254 to the register file and memory locations in shared memory/L1 cache 1270.

The shared memory/L1 cache 1270 may be an array of on-chip memory that allows for data storage and communication between the SM 1140 and the primitive engine 1135 and between threads in the SM 1140. In an embodiment, the shared memory/L1 cache 1270 comprises 128 KB of storage capacity and is in the path from the SM 1140 to the partition unit 1080. The shared memory/L1 cache 1270 can be used to cache reads and writes. One or more of the shared memory/L1 cache 1270, L2 cache 1160, and memory 1004 may be backing stores.

Combining data cache and shared memory functionality into a single memory block may provide the best overall performance for both types of memory accesses. The capacity may be usable as a cache by programs that do not use shared memory. For example, if shared memory is configured to use half of the capacity, texture and load/store operations may use the remaining capacity. Integration within the shared memory/L1 cache 1270 may enable the shared memory/L1 cache 1270 to function as a high-throughput conduit for streaming data while simultaneously providing high-bandwidth and low-latency access to frequently reused data.

When configured for general-purpose parallel computation, a simpler configuration may be used compared with graphics processing. For example, the fixed function graphics processing units shown in FIG. 10 may be bypassed, creating a much simpler programming model. In such a general-purpose parallel computation configuration, the work distribution unit 1025 may assign and distribute blocks of threads directly to the DPCs 1120. The threads in a block may execute the same program, using a unique thread ID in the calculation to ensure each thread generates unique results, using the SM 1140 to execute the program and perform calculations, shared memory/L1 cache 1270 to communicate between threads, and the LSU 1254 to read and write global memory through the shared memory/L1 cache 1270 and the memory partition unit 1080. When configured for general-purpose parallel computation, the SM 1140 may write commands that the scheduler unit 1020 can use to launch new work on the DPCs 1120.

The PPU 1000 may be included in a desktop computer, a laptop computer, a tablet computer, servers, supercomputers, a smart phone (e.g., a wireless, hand-held device), personal digital assistant (PDA), a digital camera, a vehicle, a head mounted display, a hand-held electronic device, and/or other devices. In an embodiment, the PPU 1000 is embodied on a single semiconductor substrate. In another embodiment, the PPU 1000 is included in a system-on-a-chip (SoC) along with one or more other devices such as additional PPUs 1000, the memory, a reduced instruction set computer (RISC) CPU, a memory management unit (MMU), a digital-to-analog converter (DAC), and/or others.

In an embodiment, the PPU 1000 may be included on a graphics card that includes one or more memory devices (e.g., memory 1004). The graphics card may be configured to interface with a PCIe slot on a motherboard of a desktop computer. In some embodiments, the PPU 1000 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes may be deployed in data centers, research facilities, and/or supercomputers to solve ever larger problems. As the number of processing devices within the high-performance systems increases, the communication and data transfer mechanisms may need to scale to support the increased bandwidth.

FIG. 12B is a conceptual diagram of a processing system 1200 implemented using the PPU 1000 of FIG. 10, in accordance with an embodiment. The processing system 1200 includes a CPU 1230, switch 1232, and multiple PPUs 1000 each and respective memories 1004. The NVLink 1010 may provide high-speed communication links between each of the PPUs 1000. Although a particular number of NVLink 1010 and interconnect 1002 connections are illustrated in FIG. 12B, the number of connections to each PPU 1000 and the CPU 1230 may vary. The switch 1232 may interface between the interconnect 1002 and the CPU 1230. The PPUs 1000, memories 1004, and NVLinks 1010 may be situated on a single semiconductor platform to form a parallel processing module 1225. In an embodiment, the switch 1232 supports two or more protocols to interface between various different connections and/or links.

In another embodiment (not shown), the NVLink 1010 provides one or more high-speed communication links between each of the PPUs 1000 and the CPU 1230 and the switch 1232 interfaces between the interconnect 1002 and each of the PPUs 1000. The PPUs 1000, memories 1004, and the interconnect 1002 may be situated on a single semiconductor platform to form a parallel processing module 1225. In some embodiments (not shown), the interconnect 1002 provides one or more communication links between each of the PPUs 1000 and the CPU 1230, and the switch 1232 interfaces between each of the PPUs 1000 using the NVLink 1010 to provide one or more high-speed communication links between the PPUs 1000. In some embodiments (not shown), the NVLink 1010 provides one or more high-speed communication links between the PPUs 1000 and the CPU 1230 through the switch 1232. In some embodiments (not shown), the interconnect 1002 provides one or more communication links between each of the PPUs 1000 directly. One or more of the NVLink 1010 high-speed communication links may be implemented as a physical NVLink interconnect or either an on-chip or on-die interconnect using the same protocol as the NVLink 1010.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may be situated separately or in various combinations of semiconductor platforms per the desires of the designer. In some embodiments, the parallel processing module 1225 may be implemented as a circuit board substrate and each of the PPUs 1000 and/or memories 1004 may be packaged devices. In an embodiment, the CPU 1230, switch 1232, and the parallel processing module 1225 are situated on a single semiconductor platform.

In an embodiment, the signaling rate of each NVLink 1010 is 20 to 25 Gigabits/second and each PPU 1000 includes six NVLink 1010 interfaces (as shown in FIG. 12B, five NVLink 1010 interfaces are included for each PPU 1000). Each NVLink 1010 may provide a particular data transfer rate (e.g., 25 Gigabytes/second) in each direction, with six links providing 1000 Gigabytes/second. The NVLinks 1010 may be used exclusively for PPU-to-PPU communication as shown in FIG. 12B, or some combination of PPU-to-PPU and PPU-to-CPU, when the CPU 1230 also includes one or more NVLink 1010 interfaces.

In an embodiment, the NVLink 1010 allows direct load/store/atomic access from the CPU 1230 to each PPU's 1000 memory 1004. In an embodiment, the NVLink 1010 supports coherency operations, allowing data read from the memories 1004 to be stored in the cache hierarchy of the CPU 1230, reducing cache access latency for the CPU 1230. In an embodiment, the NVLink 1010 includes support for Address Translation Services (ATS), allowing the PPU 1000 to directly access page tables within the CPU 1230. One or more of the NVLinks 1010 may be configured to operate in a low-power mode.

FIG. 12C illustrates an exemplary system 1265 in which the processing system of FIG. 12B may be implemented, in accordance with some embodiments of the present disclosure. More specifically, FIG. 12C illustrates a system 1265 comprising at least one central processing unit 1230 that is connected to a communication bus 1275. The communication bus 1275 may be implemented using any suitable protocol, such as PCI (Peripheral Component Interconnect), PCI-Express, AGP (Accelerated Graphics Port), HyperTransport, or any other bus or point-to-point communication protocol(s). The system 1265 includes a main memory 1240. Control logic (software) and data may be stored in the main memory 1240, which may take the form of random-access memory (RAM).

Continuing with the example implementation illustrated in FIG. 12C, the system 1265 includes input devices 1260, the parallel processing system 1225, and display devices 1245, e.g. a conventional CRT (cathode ray tube), LCD (liquid crystal display), LED (light emitting diode), plasma display, and/or others. User input may be received from the input devices 1260, e.g., keyboard, mouse, touchpad, microphone, etc. Each of the foregoing modules and/or devices may be situated on a single semiconductor platform to form the system 1265. In some embodiments, the various modules may be situated separately or in various combinations of semiconductor platforms.

In some embodiments, the system 1265 may be coupled to a network (e.g., a telecommunications network, local area network (LAN), wireless network, wide area network (WAN) such as the Internet, peer-to-peer network, cable network, etc.) through a network interface 1235 for communication purposes.

The system 1265 may include a secondary storage (not shown), which may include a hard disk drive and/or a removable storage drive, representing a floppy disk drive, a magnetic tape drive, a compact disk drive, digital versatile disk (DVD) drive, recording device, universal serial bus (USB) flash memory, and/or others. The removable storage drive may read from and/or write to a removable storage unit in a well-known manner.

Computer programs, or computer control logic algorithms, may be stored in the main memory 1240 and/or the secondary storage. Such computer programs, when executed, enable the system 1265 to perform various functions. The main memory 1240, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 1265 may take the form of a desktop computer, a laptop computer, a tablet computer, servers, supercomputers, a smart phone (e.g., a wireless, hand-held device), personal digital assistant (PDA), a digital camera, a vehicle, a head mounted display, a hand-held electronic device, a mobile phone device, a television, workstation, game consoles, embedded system, and/or any other device.

### Graphics Processing Pipeline

In an embodiment, the PPU 1000 comprises a graphics processing unit (GPU). The PPU 1000 may be configured to receive commands that specify shader programs for processing graphics data. Graphics data may be defined as a set of primitives such as points, lines, triangles, quads, triangle strips, and/or the like. Typically, a primitive includes data that specifies a number of vertices for the primitive (e.g., in a model-space coordinate system) as well as attributes associated with each vertex of the primitive. The PPU 1000 may be configured to process the graphics primitives to generate a frame buffer (e.g., pixel data for each of the pixels of the display).

An application may write model data for a scene (e.g., a collection of vertices and attributes) to a memory such as a system memory or memory 1004. The model data may define each of the objects that may be visible on a display. The application may then make an API call to the driver kernel that requests the model data to be rendered and displayed. The driver kernel may read the model data and write commands to the one or more streams to perform operations to process the model data. The commands may reference different shader programs to be implemented on the SMs 1140 of the PPU 1000 including one or more of a vertex shader, hull shader, domain shader, geometry shader, and a pixel shader. For example, one or more of the SMs 1140 may be configured to execute a vertex shader program that processes a number of vertices defined by the model data. In an embodiment, the different SMs 1140 may be configured to execute different shader programs concurrently. For example, a first subset of SMs 1140 may be configured to execute a vertex shader program while a second subset of SMs 1140 may be configured to execute a pixel shader program. The first subset of SMs 1140 may process vertex data to produce processed vertex data and write the processed vertex data to the L2 cache 1160 and/or the memory 1004. After the processed vertex data is rasterized (e.g., transformed from three-dimensional data into two-dimensional data in screen space) to produce fragment data, the second subset of SMs 1140 may execute a pixel shader to produce processed fragment data, which may then be blended with other processed fragment data and written to the frame buffer in memory 1004. The vertex shader program and pixel shader program may execute concurrently, processing different data from the same scene in a pipelined fashion until all of the model data for the scene has been rendered to the frame buffer. Then, the contents of the frame buffer may be transmitted to a display controller for display on a display device.

FIG. 13 is a conceptual diagram of a graphics processing pipeline 1300 implemented by the PPU 1000 of FIG. 10, in accordance with an embodiment. The graphics processing pipeline 1300 is an abstract flow diagram of the processing steps implemented to generate 2D computer-generated images from 3D geometry data. As will be understood, pipeline architectures may perform long latency operations more efficiently by splitting up the operation into a plurality of stages, where the output of each stage is coupled to the input of the next successive stage. Thus, the graphics processing pipeline 1300 may receive input data 1301 that is transmitted from one stage to the next stage of the graphics processing pipeline 1300 to generate output data 1302. In an embodiment, the graphics processing pipeline 1300 may represent a graphics processing pipeline defined by the OpenGL® API. In some embodiments, the graphics processing pipeline 1300 may be implemented using the some or all of the functionality and architectures described herein.

As shown in FIG. 13, the graphics processing pipeline 1300 comprises a pipeline architecture that includes a number of stages. The stages may include a data assembly stage 1310, a vertex shading stage 1320, a primitive assembly stage 1330, a geometry shading stage 1340, a viewport scale, cull, and clip (VSCC) stage 1350, a rasterization stage 1360, a fragment shading stage 1370, and a raster operations stage 1380. In an embodiment, the input data 1301 comprises commands that configure the processing units to implement the stages of the graphics processing pipeline 1300 and geometric primitives (e.g., points, lines, triangles, quads, triangle strips or fans, etc.) to be processed by the stages. The output data 1302 may comprise pixel data (e.g., color data) that is copied into a frame buffer or other type of surface data structure in a memory.

The data assembly stage 1310 may receive the input data 1301 that specifies vertex data for high-order surfaces, primitives, or the like. The data assembly stage 1310 may collect the vertex data in a temporary storage or queue, such as by receiving a command from the host processor that includes a pointer to a buffer in memory and reading the vertex data from the buffer. The vertex data may then be transmitted to the vertex shading stage 1320 for processing.

The vertex shading stage 1320 may process vertex data by performing a set of operations (e.g., a vertex shader or a program) once for each of the vertices. Vertices may be, e.g., specified as a 4-coordinate vector (e.g., <x, y, z, w>) associated with one or more vertex attributes (e.g., color, texture coordinates, surface normal, etc.). The vertex shading stage 1320 may manipulate individual vertex attributes such as position, color, texture coordinates, and the like. In other words, the vertex shading stage 1320 may perform operations on the vertex coordinates or other vertex attributes associated with a vertex. Such operations may include lighting operations (e.g., modifying color attributes for a vertex) and/or transformation operations (e.g., modifying the coordinate space for a vertex). For example, vertices may be specified using coordinates in an object-coordinate space, which may be transformed by multiplying the coordinates by a matrix that translates the coordinates from the object-coordinate space into a world space or a normalized-device-coordinate (NCD) space. The vertex shading stage 1320 may generate transformed vertex data that is transmitted to the primitive assembly stage 1330.

The primitive assembly stage 1330 may collect vertices output by the vertex shading stage 1320 and group the vertices into geometric primitives for processing by the geometry shading stage 1340. For example, the primitive assembly stage 1330 may be configured to group every three consecutive vertices as a geometric primitive (e.g., a triangle) for transmission to the geometry shading stage 1340. In some embodiments, specific vertices may be reused for consecutive geometric primitives (e.g., two consecutive triangles in a triangle strip may share two vertices). The primitive assembly stage 1330 may transmit geometric primitives (e.g., a collection of associated vertices) to the geometry shading stage 1340.

The geometry shading stage 1340 may process geometric primitives by performing a set of operations (e.g., a geometry shader or program) on the geometric primitives. Tessellation operations may generate one or more geometric primitives from each geometric primitive. In other words, the geometry shading stage 1340 may subdivide each geometric primitive into a finer mesh of two or more geometric primitives for processing by the rest of the graphics processing pipeline 1300. The geometry shading stage 1340 may transmit geometric primitives to the VSCC stage 1350.

In an embodiment, the graphics processing pipeline 1300 may operate within a streaming multiprocessor and the vertex shading stage 1320, the primitive assembly stage 1330, the geometry shading stage 1340, the fragment shading stage 1370, and/or hardware/software associated therewith, may sequentially perform processing operations. Once the sequential processing operations are complete, in an embodiment, the VSCC stage 1350 may utilize the data. In an embodiment, primitive data processed by one or more of the stages in the graphics processing pipeline 1300 may be written to a cache (e.g. L1 cache, a vertex cache, etc.). In this case, in an embodiment, the VSCC stage 1350 may access the data in the cache. In an embodiment, the VSCC stage 1350 and the rasterization stage 1360 are implemented as fixed function circuitry.

The VSCC stage 1350 may perform viewport scaling, culling, and clipping of the geometric primitives. Each surface being rendered may be associated with an abstract camera position representing a location of a viewer looking at the scene and defining a viewing frustum that encloses the objects of the scene. The viewing frustum may include a viewing plane, a rear plane, and four clipping planes. Any geometric primitive entirely outside of the viewing frustum may be culled (e.g., discarded) because the geometric primitive will not contribute to the final rendered scene. Any geometric primitive that is partially inside the viewing frustum and partially outside the viewing frustum may be clipped (e.g., transformed into a new geometric primitive that is enclosed within the viewing frustum). Furthermore, geometric primitives may each be scaled based on a depth of the viewing frustum. All potentially visible geometric primitives may be transmitted to the rasterization stage 1360.

The rasterization stage 1360 may convert the 3D geometric primitives into 2D fragments (e.g. capable of being utilized for display, etc.). The rasterization stage 1360 may be configured to utilize the vertices of the geometric primitives to setup a set of plane equations from which various attributes can be interpolated. The rasterization stage 1360 may compute a coverage mask for a plurality of pixels that indicates whether one or more sample locations for the pixel intercept the geometric primitive. In an embodiment, z-testing may be performed to determine if the geometric primitive is occluded by other geometric primitives that have already been rasterized. The rasterization stage 1360 may generate fragment data (e.g., interpolated vertex attributes associated with a particular sample location for each covered pixel) that are transmitted to the fragment shading stage 1370.

The fragment shading stage 1370 may process fragment data by performing a set of operations (e.g., a fragment shader or a program) on each of the fragments. The fragment shading stage 1370 may generate pixel data (e.g., color values) for the fragment such as by performing lighting operations or sampling texture maps using interpolated texture coordinates for the fragment. The fragment shading stage 1370 may generate pixel data that is transmitted to the raster operations stage 1380.

The raster operations stage 1380 may perform various operations on the pixel data such as performing alpha tests, stencil tests, and blending the pixel data with other pixel data corresponding to other fragments associated with the pixel. When the raster operations stage 1380 has finished processing the pixel data (e.g., the output data 1302), the pixel data may be written to a render target such as a frame buffer, a color buffer, or the like.

It will be appreciated that one or more stages may additionally or alternatively be included in the graphics processing pipeline 1300 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading stage 1340). Other types of graphics processing pipelines are contemplated as being within the scope of the present disclosure. Furthermore, any of the stages of the graphics processing pipeline 1300 may be implemented by one or more dedicated hardware units within a graphics processor such as PPU 1000. Other stages of the graphics processing pipeline 1300 may be implemented by programmable hardware units such as the SM 1140 of the PPU 1000.

The graphics processing pipeline 1300 may be implemented via an application executed by a host processor, such as a CPU. In an embodiment, a device driver may implement an application programming interface (API) that defines various functions that can be utilized by an application in order to generate graphical data for display. The device driver may be a software program that includes a plurality of instructions that control the operation of the PPU 1000. The API may provide an abstraction for a programmer that lets a programmer utilize specialized graphics hardware, such as the PPU 1000, to generate the graphical data without requiring the programmer to utilize the specific instruction set for the PPU 1000. The application may include an API call that is routed to the device driver for the PPU 1000. The device driver may interpret the API call and perform various operations to respond to the API call. In some instances, the device driver may perform operations by executing instructions on the CPU. In some instances, the device driver may perform operations, at least in part, by launching operations on the PPU 1000 utilizing an input/output interface between the CPU and the PPU 1000. In an embodiment, the device driver is configured to implement the graphics processing pipeline 1300 utilizing the hardware of the PPU 1000.

Various programs may be executed within the PPU 1000 in order to implement the various stages of the graphics processing pipeline 1300. For example, the device driver may launch a kernel on the PPU 1000 to perform the vertex shading stage 1320 on one SM 1140 (or multiple SMs 1140). The device driver (or the initial kernel executed by the PPU 1000) may launch other kernels on the PPU 1000 to perform other stages of the graphics processing pipeline 1300, such as the geometry shading stage 1340 and the fragment shading stage 1370. In some embodiments, some stages of the graphics processing pipeline 1300 may be implemented on fixed unit hardware such as a rasterizer or a data assembler implemented within the PPU 1000. It will be appreciated that results from one kernel may be processed by one or more intervening fixed function hardware units before being processed by a subsequent kernel on an SM 1140.

### Example Computing Device

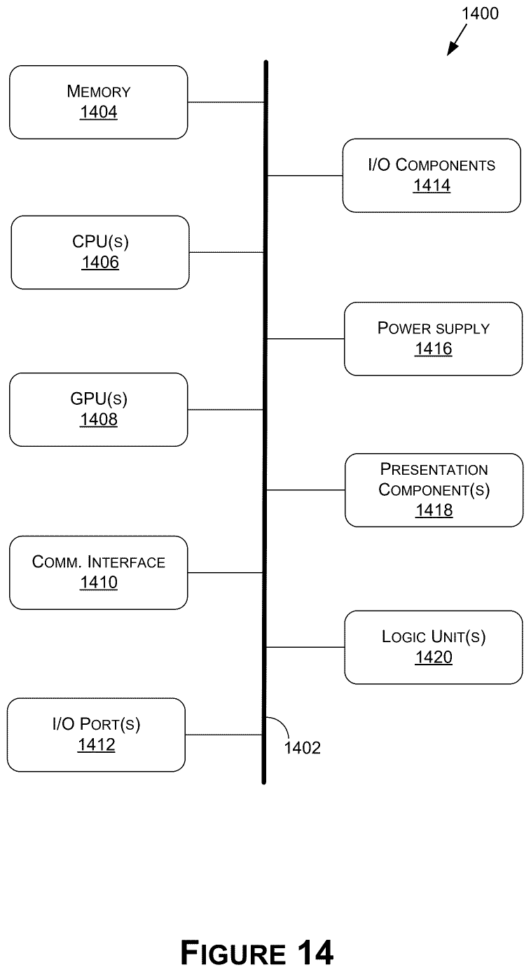

FIG. 14 is a block diagram of an example computing device(s) 1400 suitable for use in implementing some embodiments of the present disclosure. Computing device 1400 may include an interconnect system 1402 that directly or indirectly couples the following devices: memory 1404, one or more central processing units (CPUs) 1406, one or more graphics processing units (GPUs) 1408, a communication interface 1410, input/output (I/O) ports 1412, input/output components 1414, a power supply 1416, one or more presentation components 1418 (e.g., display(s), speaker(s), etc.), and one or more logic units 1420. In at least one embodiment, the computing device(s) 1400 may comprise one or more virtual machines (VMs), and/or any of the components thereof may comprise virtual components (e.g., virtual hardware components). For non-limiting examples, one or more of the GPUs 1408 may comprise one or more vGPUs, one or more of the CPUs 1406 may comprise one or more vCPUs, and/or one or more of the logic units 1420 may comprise one or more virtual logic units. As such, a computing device(s) 1400 may include discrete components (e.g., a full GPU dedicated to the computing device 1400), virtual components (e.g., a portion of a GPU dedicated to the computing device 1400), or a combination thereof.

Although the various blocks of FIG. 14 are shown as connected via the interconnect system 1402 with lines, this is not intended to be limiting and is for clarity only. For example, in some embodiments, a presentation component 1418, such as a display device, may be considered an I/O component 1414 (e.g., if the display is a touch screen). As another example, the CPUs 1406 and/or GPUs 1408 may include memory (e.g., the memory 1404 may be representative of a storage device in addition to the memory of the GPUs 1408, the CPUs 1406, and/or other components). As such, the computing device of FIG. 14 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 14.

The interconnect system 1402 may represent one or more links or busses, such as an address bus, a data bus, a control bus, or a combination thereof. The interconnect system 1402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1406 may be directly connected to the memory 1404. Further, the CPU 1406 may be directly connected to the GPU 1408. Where there is direct, or point-to-point connection between components, the interconnect system 1402 may include a PCIe link to carry out the connection. In these examples, a PCI bus need not be included in the computing device 1400.

The memory 1404 may include any of a variety of computer-readable media. The computer-readable media may be any available media that may be accessed by the computing device 1400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1406 may be configured to execute at least some of the computer-readable instructions to control one or more components of the computing device 1400 to perform one or more of the methods and/or processes described herein. The CPU(s) 1406 may each include one or more cores (e.g., one, two, four, eight, twenty-eight, seventy-two, etc.) that are capable of handling a multitude of software threads simultaneously. The CPU(s) 1406 may include any type of processor, and may include different types of processors depending on the type of computing device 1400 implemented (e.g., processors with fewer cores for mobile devices and processors with more cores for servers). For example, depending on the type of computing device 1400, the processor may be an Advanced RISC Machines (ARM) processor implemented using Reduced Instruction Set Computing (RISC) or an x86 processor implemented using Complex Instruction Set Computing (CISC). The computing device 1400 may include one or more CPUs 1406 in addition to one or more microprocessors or supplementary co-processors, such as math co-processors.

In addition to or alternatively from the CPU(s) 1406, the GPU(s) 1408 may be configured to execute at least some of the computer-readable instructions to control one or more components of the computing device 1400 to perform one or more of the methods and/or processes described herein. One or more of the GPU(s) 1408 may be an integrated GPU (e.g., with one or more of the CPU(s) 1406 and/or one or more of the GPU(s) 1408 may be a discrete GPU. In embodiments, one or more of the GPU(s) 1408 may be a coprocessor of one or more of the CPU(s) 1406. The GPU(s) 1408 may be used by the computing device 1400 to render graphics (e.g., 3D graphics) or perform general purpose computations. For example, the GPU(s) 1408 may be used for General-Purpose computing on GPUs (GPGPU). The GPU(s) 1408 may include hundreds or thousands of cores that are capable of handling hundreds or thousands of software threads simultaneously. The GPU(s) 1408 may generate pixel data for output images in response to rendering commands (e.g., rendering commands from the CPU(s) 1406 received via a host interface). The GPU(s) 1408 may include graphics memory, such as display memory, for storing pixel data or any other suitable data, such as GPGPU data. The display memory may be included as part of the memory 1404. The GPU(s) 1408 may include two or more GPUs operating in parallel (e.g., via a link). The link may directly connect the GPUs (e.g., using NVLINK) or may connect the GPUs through a switch (e.g., using NVSwitch). When combined together, each GPU 1408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1406 and/or the GPU(s) 1408, the logic unit(s) 1420 may be configured to execute at least some of the computer-readable instructions to control one or more components of the computing device 1400 to perform one or more of the methods and/or processes described herein. In embodiments, the CPU(s) 1406, the GPU(s) 1408, and/or the logic unit(s) 1420 may discretely or jointly perform any combination of the methods, processes and/or portions thereof. One or more of the logic units 1420 may be part of and/or integrated in one or more of the CPU(s) 1406 and/or the GPU(s) 1408 and/or one or more of the logic units 1420 may be discrete components or otherwise external to the CPU(s) 1406 and/or the GPU(s) 1408. In embodiments, one or more of the logic units 1420 may be a coprocessor of one or more of the CPU(s) 1406 and/or one or more of the GPU(s) 1408.

Examples of the logic unit(s) 1420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Deep Learning Accelerator Clusters (XNNs), Neural Processing Units (NPUs), Neural Network Accelerators (NNAs), Programmable Vision Accelerators (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1410 may include one or more receivers, transmitters, and/or transceivers that allow the computing device 1400 to communicate with other computing devices via an electronic communication network, included wired and/or wireless communications. The communication interface 1410 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1420 and/or communication interface 1410 may include one or more data processing units (DPUs) to transmit data received over a network and/or through interconnect system 1402 directly to (e.g., a memory of) one or more GPU(s) 1408.

The I/O ports 1412 may allow the computing device 1400 to be logically coupled to other devices including the I/O components 1414, the presentation component(s) 1418, and/or other components, some of which may be built in to (e.g., integrated in) the computing device 1400. Illustrative I/O components 1414 include a microphone, mouse, keyboard, joystick, game pad, game controller, satellite dish, scanner, printer, wireless device, etc. The I/O components 1414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 1400 may be include depth cameras, such as stereoscopic camera systems, infrared camera systems, RGB camera systems, touchscreen technology, and combinations of these, for gesture detection and recognition. Additionally, the computing device 1400 may include accelerometers or gyroscopes (e.g., as part of an inertia measurement unit (IMU)) that allow detection of motion. In some examples, the output of the accelerometers or gyroscopes may be used by the computing device 1400 to render immersive augmented reality or virtual reality.

The power supply 1416 may include a hard-wired power supply, a battery power supply, or a combination thereof. The power supply 1416 may provide power to the computing device 1400 to allow the components of the computing device 1400 to operate.

The presentation component(s) 1418 may include a display (e.g., a monitor, a touch screen, a television screen, a heads-up-display (HUD), other display types, or a combination thereof), speakers, and/or other presentation components. The presentation component(s) 1418 may receive data from other components (e.g., the GPU(s) 1408, the CPU(s) 1406, DPUs, etc.), and output the data (e.g., as an image, video, sound, etc.).

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1400 of FIG. 14—e.g., each device may include similar components, features, and/or functionality of the computing device(s) 1400. In addition, where backend devices (e.g., servers, NAS, etc.) are implemented, the backend devices may be included as part of a data center (such as, but not limited to, those described herein).

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1400 described herein with respect to FIG. 14. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### Example Data Center

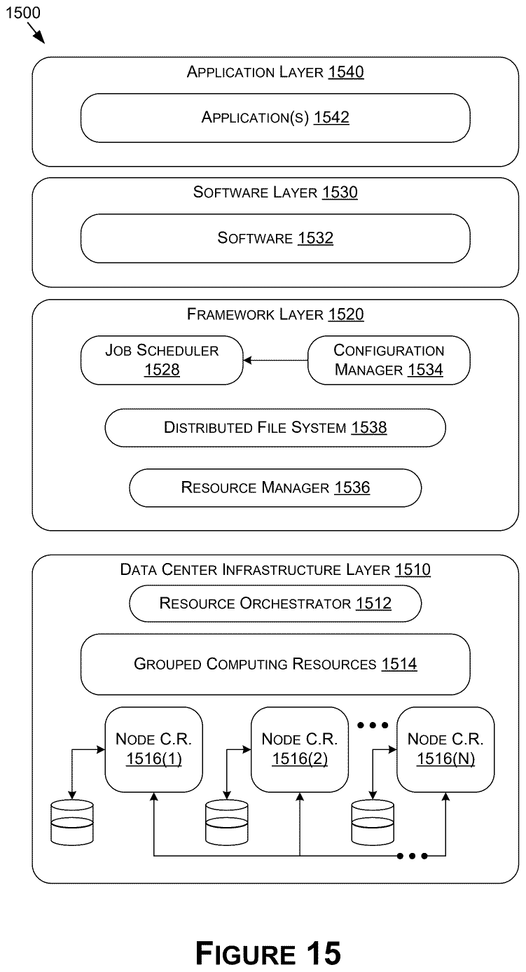

FIG. 15 illustrates an example data center 1500 that may be used in at least one embodiments of the present disclosure. The data center 1500 may include a data center infrastructure layer 1510, a framework layer 1520, a software layer 1530, and/or an application layer 1540.

As shown in FIG. 15, the data center infrastructure layer 1510 may include a resource orchestrator 1512, grouped computing resources 1514, and node computing resources (“node C.R.s”) 1516(1)-1516(N), where “N” represents any whole, positive integer. In at least one embodiment, node C.R.s 1516(1)-1516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1516(1)-1516(N) may correspond to a server having one or more of the above-mentioned computing resources. In addition, in some embodiments, the node C.R.s 1516(1)-15161(N) may include one or more virtual components, such as vGPUs, vCPUs, and/or the like, and/or one or more of the node C.R.s 1516(1)-1516(N) may correspond to a virtual machine (VM).

In at least one embodiment, grouped computing resources 1514 may include separate groupings of node C.R.s 1516 housed within one or more racks (not shown), or many racks housed in data centers at various geographical locations (also not shown). Separate groupings of node C.R.s 1516 within grouped computing resources 1514 may include grouped compute, network, memory or storage resources that may be configured or allocated to support one or more workloads. In at least one embodiment, several node C.R.s 1516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1512 may configure or otherwise control one or more node C.R.s 1516(1)-1516(N) and/or grouped computing resources 1514. In at least one embodiment, resource orchestrator 1512 may include a software design infrastructure (SDI) management entity for the data center 1500. The resource orchestrator 1512 may include hardware, software, or some combination thereof.

In at least one embodiment, as shown in FIG. 15, framework layer 1520 may include a job scheduler 1528, a configuration manager 1534, a resource manager 1536, and/or a distributed file system 1538. The framework layer 1520 may include a framework to support software 1532 of software layer 1530 and/or one or more application(s) 1542 of application layer 1540. The software 1532 or application(s) 1542 may respectively include web-based service software or applications, such as those provided by Amazon Web Services, Google Cloud and Microsoft Azure. The framework layer 1520 may be, but is not limited to, a type of free and open-source software web application framework such as Apache Spark™ (hereinafter “Spark”) that may use distributed file system 1538 for large-scale data processing (e.g., “big data”). In at least one embodiment, job scheduler 1528 may include a Spark driver to facilitate scheduling of workloads supported by various layers of data center 1500. The configuration manager 1534 may be capable of configuring different layers such as software layer 1530 and framework layer 1520 including Spark and distributed file system 1538 for supporting large-scale data processing. The resource manager 1536 may be capable of managing clustered or grouped computing resources mapped to or allocated for support of distributed file system 1538 and job scheduler 1528. In at least one embodiment, clustered or grouped computing resources may include grouped computing resource 1514 at data center infrastructure layer 1510. The resource manager 1536 may coordinate with resource orchestrator 1512 to manage these mapped or allocated computing resources.

In at least one embodiment, software 1532 included in software layer 1530 may include software used by at least portions of node C.R.s 1516(1)-1516(N), grouped computing resources 1514, and/or distributed file system 1538 of framework layer 1520. One or more types of software may include, but are not limited to, Internet web page search software, e-mail virus scan software, database software, and streaming video content software.

In at least one embodiment, application(s) 1542 included in application layer 1540 may include one or more types of applications used by at least portions of node C.R.s 1516(1)-1516(N), grouped computing resources 1514, and/or distributed file system 1538 of framework layer 1520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1534, resource manager 1536, and resource orchestrator 1512 may implement any number and type of self-modifying actions based on any amount and type of data acquired in any technically feasible fashion. Self-modifying actions may relieve a data center operator of data center 1500 from making possibly bad configuration decisions and possibly avoiding underutilized and/or poor performing portions of a data center.

The data center 1500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1500. In at least one embodiment, trained or deployed machine learning models corresponding to one or more neural networks may be used to infer or predict information using resources described above with respect to the data center 1500 by using weight parameters calculated through one or more training techniques, such as but not limited to those described herein.

In at least one embodiment, the data center 1500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1400 of FIG. 14—e.g., each device may include similar components, features, and/or functionality of the computing device(s) 1400. In addition, where backend devices (e.g., servers, NAS, etc.) are implemented, the backend devices may be included as part of a data center 1500, an example of which is described in more detail herein with respect to FIG. 15.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1400 described herein with respect to FIG. 14. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a talking kiosk, a remote control, an appliance, a consumer electronic device, a workstation, an edge device, any combination of these delineated devices, or any other suitable device.

### Example Clauses

Clause 1. One or more processors comprising processing circuitry to generate, for at least one pixel of one or more pixels of a current frame depicting a scene, a parametric representation of a current location on a limit surface of the scene corresponding to the pixel.
Clause 2. The one or more processors of clause 1, wherein the processing circuitry is further to compute, based at least on the parametric representation for the at least one pixel of the one or more pixels, a previous location on the limit surface corresponding to a previous frame.
Clause 3. The one or more processors of clause 1 or 2, wherein the processing circuitry is further to reconstruct a motion vector based at least on the current location and the previous location on the limit surface.
Clause 4. The one or more processors of clause 1, 2 or 3, wherein the processing circuitry is further to denoise the current frame based at least on the motion vector.
Clause 5. The one or more processors of clause 1, 2, 3 or 4, wherein the processing circuitry is further to determine, for the at least one pixel of the one or more pixels, whether the pixel corresponds to a parametric surface.
Clause 6. The one or more processors of clause 1, 2, 3 or 4, wherein at least one pixel of the one or more pixels represents a rendered surface that approximates the limit surface or represents a displaced surface derived from the limit surface.
Clause 7. The one or more processors of clause 1, 2, 3 or 4, wherein the processing circuitry is further to include, in the parametric representation for the at least one pixel of the one or more pixels, a representation of a patch of the limit surface and a parametric location in the patch corresponding to the current location on the limit surface.
Clause 8. The one or more processors of clause 1, 2, 3 or 4, wherein the processing circuitry is further to compute the current location on the limit surface in three-dimensions based at least on the parametric representation of the current location.
Clause 9. The one or more processors of clause 1, 2, 3 or 4, wherein the processing circuitry is further to compute the reconstructed previous location on the limit surface based at least on a cached, posed control cage associated with the previous frame.
Clause 10. The one or more processors of clause 1, 2, 3 or 4, wherein the processing circuitry is further to compute the motion vector based at least on comparing projected representations of the current location and the reconstructed previous location on the limit surface in screen space.
Clause 11. The one or more processors of clause 1, 2, 3 or 4, wherein the limit surface corresponds to a rendered surface that approximates a geometrically refined parametric surface.
Clause 12. The one or more processors of clause 1, 2, 3 or 4, wherein the processing circuitry is further to generate the current frame based on at least one of rasterization of the one or more pixels or tracing one or more rays from the one or more pixels.
Clause 13. The one or more processors of clause 1, 2, 3 or 4, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; or a system that incorporates one or more machine learning models deployed in a service or microservice along with an OS-level virtualization package (e.g., a container).
Clause 14. A system comprising one or more parallel processors to generate, for each pixel of one or more pixels of a current frame of a scene, a parametric location corresponding to a current location on a rendered parametric surface of the scene represented by the pixel.
Clause 15. The system of clause 14, wherein the one or more parallel processors are further to reconstruct, based at least on the parametric location for each pixel of the one or more pixels, a previous location on the rendered parametric surface corresponding to a previous frame.
Clause 16. The system of clause 14 or 15, wherein the one or more parallel processors are further to compute a motion vector based at least on the current location and the reconstructed previous location on the rendered parametric surface.
Clause 17. The system of clause 14, 15, or 16, wherein the one or more parallel processors are further to denoise the current frame based at least on the motion vector.
Clause 18. The system of clause 14, 15, 16 or 17, wherein the rendered parametric surface approximates a limit surface or a displaced surface derived from the limit surface.
Clause 19. The system of clause 14, 15, 16 or 17, wherein the one or more parallel processors are further to generate a representation of the parametric location comprising, for each pixel of the one or more pixels, a representation of a patch of the rendered parametric surface and the parametric location in the patch corresponding to the current location on the rendered parametric surface.
Clause 20. The system of clause 14, 15, 16 or 17, wherein the one or more parallel processors are further to compute the reconstructed previous location on the rendered parametric surface based at least on a cached, posed control cage associated with the previous frame.
Clause 21. The system of clause 14, 15, 16 or 17, wherein the one or more parallel processors are further to compute the motion vector based at least on comparing projected representations of the current location and the reconstructed previous location on the rendered parametric surface in screen space.
Clause 22. The system of clause 14, 15, 16 or 17, wherein the rendered parametric surface approximates a geometrically refined parametric surface.
Clause 23. The system of clause 14, 15, 16 or 17, wherein the one or more parallel processors are further to generate the current frame based on at least one of rasterization of the one or more pixels or tracing one or more rays from the one or more pixels.
Clause 24. The system of clause 14, 15, 16 or 17, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; or a system that incorporates one or more machine learning models deployed in a service or microservice along with an OS-level virtualization package (e.g., a container).
Clause 25. A method comprising obtaining a parametric location corresponding to a current location on a rendered parametric surface represented by at least one pixel of one or more pixels of a current frame.
Clause 26. The method of clause 25, further comprising reconstructing a previous location on the rendered parametric surface corresponding to a previous frame based at least on the parametric location for the at least one pixel of the one or more pixels.
Clause 27. The method of clause 25 or 26, further comprising denoising the current frame based at least on a motion vector corresponding to the current location and the previous location on the rendered parametric surface for the at least one pixel of the one or more pixels.
Clause 28. The method of clause 25, 26 or 27, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; or a system that incorporates one or more machine learning models deployed in a service or microservice along with an OS-level virtualization package (e.g., a container).
Clause 29. One or more processors comprising processing circuitry to compute, for at least one pixel of one or more pixels of a current frame, a current location on a displaced surface corresponding to the pixel.
Clause 30. The one or more processors of clause 29, wherein the processing circuitry is further to compute, for the at least one pixel of the one or more pixels based at least on a parametric representation of the current location on the displaced surface corresponding to the pixel, a reconstructed previous location on a limit surface corresponding to the displaced surface in a previous frame.
Clause 31. The one or more processors of clause 29 or 30, wherein the processing circuitry is further to compute a motion vector based at least on the current location on the displaced surface and the reconstructed previous location on the limit surface.
Clause 32. The one or more processors of clause 29, 30 or 31, wherein the processing circuitry is further to denoise the current frame based at least on the motion vector.
Clause 33. The one or more processors of clause 29, 30, 31 or 32, wherein the processing circuitry is further to compute, for the at least one pixel of the one or more pixels, the current location on the displaced surface based at least on cached depth and a corresponding viewport configuration.
Clause 34. The one or more processors of clause 29, 30, 31 or 32, wherein the processing circuitry is further to compute the motion vector based at least on comparing representations of the current location on the displaced surface and a previous location on the displaced surface.
Clause 35. The one or more processors of clause 29, 30, 31, 32 or 34, wherein the processing circuitry is further to reconstruct the previous location on the displaced surface based at least on the parametric representation of the current location and a displacement function corresponding to the displaced surface.
Clause 36. The one or more processors of clause 29, 30, 31, 32 or 34, wherein the processing circuitry is further to compute the current location on the displaced surface based at least on reconstructing a current location on the limit surface using the parametric representation and applying a displacement function corresponding to the displaced surface.
Clause 37. The one or more processors of clause 29, 30, 31 or 32, wherein the processing circuitry is further to reconstruct displacement between a current location on the limit surface and the current location on the displaced surface, reconstruct a previous location on the displaced surface based at least on applying the reconstructed displacement to the reconstructed previous location on the limit surface, and compute the motion vector based at least on the current location and the previous location on the displaced surface.
Clause 38. The one or more processors of clause 29, 30, 31 or 32, wherein the processing circuitry is further to wherein the displaced surface approximates a geometrically refined parametric surface.
Clause 39. The one or more processors of clause 29, 30, 31 or 32, wherein the processing circuitry is further to generate the current frame based on at least one of rasterization of the one or more pixels or tracing one or more rays from the one or more pixels.
Clause 40. The one or more processors of clause 29, 30, 31 or 32, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; or a system that incorporates one or more machine learning models deployed in a service or microservice along with an OS-level virtualization package (e.g., a container).
Clause 41. A system comprising one or more parallel processors to compute, for each pixel of one or more pixels of a current frame, a parametric location corresponding to a current location on a displaced parametric surface the pixel represents.
Clause 42. The system of clause 41, wherein the one or more parallel processors are further to reconstruct, for each pixel of the one or more pixels based at least on the parametric location for each pixel of the one or more pixels, a previous location on a limit surface corresponding to the displaced parametric surface in a previous frame.
Clause 43. The system of clause 41 or 42, wherein the one or more parallel processors are further to compute a motion vector based at least on the current location on the displaced parametric surface and the reconstructed previous location on the limit surface.
Clause 44. The system of clause 41, 42, or 43, wherein the one or more parallel processors are further to denoise the current frame based at least on the motion vector.
Clause 45. The system of clause 41, 42, 43 or 44, wherein the one or more parallel processors are further to compute, for each pixel of the one or more pixels, the current location on the displaced parametric surface based at least on cached depth and a corresponding camera configuration.
Clause 46. The system of clause 41, 42, 43 or 44, wherein the one or more parallel processors are further to compute the motion vector based at least on comparing representations of the current location on the displaced parametric surface and a previous location on the displaced parametric surface.
Clause 47. The system of clause 41, 42, 43, 44 or 46, wherein the one or more parallel processors are further to reconstruct the previous location on the displaced parametric surface based at least on the parametric location corresponding to the current location and a displacement function corresponding to the displaced parametric surface.
Clause 48. The system of clause 41, 42, 43, 44 or 46, wherein the one or more parallel processors are further to compute the current location on the displaced parametric surface based at least on reconstructing a current location on the limit surface using the parametric location and applying a displacement function corresponding to the displaced parametric surface.
Clause 49. The system of clause 41, 42, 43 or 44, wherein the one or more parallel processors are further to reconstruct displacement between a current location on the limit surface and the current location on the displaced parametric surface, reconstruct a previous location on the displaced parametric surface based at least on applying the reconstructed displacement to the reconstructed previous location on the limit surface, and compute the motion vector based at least on the current location and the previous location on the displaced parametric surface.
Clause 50. The system of clause 41, 42, 43 or 44, wherein the displaced parametric surface approximates a geometrically refined parametric surface.
Clause 51. The system of clause 41, 42, 43 or 44, wherein the one or more parallel processors are further to generate the current frame based on at least one of rasterization of the one or more pixels or tracing one or more rays from the one or more pixels.
Clause 52. The system of clause 41, 42, 43 or 44, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; or a system that incorporates one or more machine learning models deployed in a service or microservice along with an OS-level virtualization package (e.g., a container).
Clause 53. A method comprising obtaining a parametric location corresponding to a current location on a displaced parametric surface represented by each pixel of one or more pixels of a current frame.
Clause 54. The method of clause 53, further comprising reconstructing a previous location, in a previous frame, on a limit surface corresponding to the displaced parametric surface based at least on the parametric location for each pixel of the one or more pixels.
Clause 55. The method of clause 53 or 54, further comprising denoising the current frame using a motion vector computed based at least on the current location on the displaced parametric surface and the previous location on the limit surface for each pixel of the one or more pixels.
Clause 56. The method of clause 53, 54 or 55, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; or a system that incorporates one or more machine learning models deployed in a service or microservice along with an OS-level virtualization package (e.g., a container).

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
compute, for at least one pixel of one or more pixels of a current frame, a current location on a displaced surface corresponding to the pixel;
compute, for the at least one pixel of the one or more pixels based at least on a parametric representation of the current location on the displaced surface corresponding to the pixel, a reconstructed previous location on a limit surface corresponding to the displaced surface in a previous frame;
compute a motion vector based at least on the current location on the displaced surface and the reconstructed previous location on the limit surface; and
denoise the current frame based at least on the motion vector.

2. The one or more processors of claim 1, wherein the processing circuitry is further to compute, for the at least one pixel of the one or more pixels, the current location on the displaced surface based at least on cached depth and a corresponding viewport configuration.

3. The one or more processors of claim 1, wherein the processing circuitry is further to compute the motion vector based at least on comparing representations of the current location on the displaced surface and a previous location on the displaced surface.

4. The one or more processors of claim 3, wherein the processing circuitry is further to reconstruct the previous location on the displaced surface based at least on the parametric representation of the current location and a displacement function corresponding to the displaced surface.

5. The one or more processors of claim 3, wherein the processing circuitry is further to compute the current location on the displaced surface based at least on reconstructing a current location on the limit surface using the parametric representation and applying a displacement function corresponding to the displaced surface.

6. The one or more processors of claim 1, wherein the processing circuitry is further to reconstruct displacement between a current location on the limit surface and the current location on the displaced surface, reconstruct a previous location on the displaced surface based at least on applying the reconstructed displacement to the reconstructed previous location on the limit surface, and compute the motion vector based at least on the current location and the previous location on the displaced surface.

7. The one or more processors of claim 1, wherein the processing circuitry is further to wherein the displaced surface approximates a geometrically refined parametric surface.

8. The one or more processors of claim 1, wherein the processing circuitry is further to generate the current frame based on at least one of rasterization of the one or more pixels or tracing one or more rays from the one or more pixels.

9. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center;
a system implemented at least partially using cloud computing resources;
a system using or deploying one or more inference microservices; or
a system that incorporates one or more machine learning models deployed in a service or microservice along with an OS-level virtualization package (e.g., a container).

10. A system comprising one or more parallel processors to:
compute, for each pixel of one or more pixels of a current frame, a parametric location corresponding to a current location on a displaced parametric surface the pixel represents;
reconstruct, for each pixel of the one or more pixels based at least on the parametric location for each pixel of the one or more pixels, a previous location on a limit surface corresponding to the displaced parametric surface in a previous frame;
compute a motion vector based at least on the current location on the displaced parametric surface and the reconstructed previous location on the limit surface; and
denoise the current frame based at least on the motion vector.

11. The system of claim 10, wherein the one or more parallel processors are further to compute, for each pixel of the one or more pixels, the current location on the displaced parametric surface based at least on cached depth and a corresponding camera configuration.

12. The system of claim 10, wherein the one or more parallel processors are further to compute the motion vector based at least on comparing representations of the current location on the displaced parametric surface and a previous location on the displaced parametric surface.

13. The system of claim 12, wherein the one or more parallel processors are further to reconstruct the previous location on the displaced parametric surface based at least on the parametric location corresponding to the current location and a displacement function corresponding to the displaced parametric surface.

14. The system of claim 12, wherein the one or more parallel processors are further to compute the current location on the displaced parametric surface based at least on reconstructing a current location on the limit surface using the parametric location and applying a displacement function corresponding to the displaced parametric surface.

15. The system of claim 10, wherein the one or more parallel processors are further to reconstruct displacement between a current location on the limit surface and the current location on the displaced parametric surface, reconstruct a previous location on the displaced parametric surface based at least on applying the reconstructed displacement to the reconstructed previous location on the limit surface, and compute the motion vector based at least on the current location and the previous location on the displaced parametric surface.

16. The system of claim 10, wherein the displaced parametric surface approximates a geometrically refined parametric surface.

17. The system of claim 10, wherein the one or more parallel processors are further to generate the current frame based on at least one of rasterization of the one or more pixels or tracing one or more rays from the one or more pixels.

18. The system of claim 10, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center;
a system implemented at least partially using cloud computing resources;
a system using or deploying one or more inference microservices; or
a system that incorporates one or more machine learning models deployed in a service or microservice along with an OS-level virtualization package (e.g., a container).

19. A method comprising:
obtaining a parametric location corresponding to a current location on a displaced parametric surface represented by each pixel of one or more pixels of a current frame;
reconstructing a previous location, in a previous frame, on a limit surface corresponding to the displaced parametric surface based at least on the parametric location for each pixel of the one or more pixels; and
denoising the current frame using a motion vector computed based at least on the current location on the displaced parametric surface and the previous location on the limit surface for each pixel of the one or more pixels.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center;
a system implemented at least partially using cloud computing resources;
a system using or deploying one or more inference microservices; or
a system that incorporates one or more machine learning models deployed in a service or microservice along with an OS-level virtualization package (e.g., a container).
